(19) United States
(12) Patent Application Publication
(10) Pub. No.: US 2026/0032551 A1
(43) Pub. Date: Jan. 29, 2026

(54) METHOD AND APPARATUS FOR HANDLING BACKHAUL CONFIGURATION IN A WIRELESS COMMUNICATION SYSTEM

(71) Applicant: Samsung Electronics Co., Ltd., Suwon-si (KR)

(72) Inventors: Lalith KUMAR, Bangalore (IN); Utsav SINHA, Bangalore (IN); Aman AGARWAL, Bangalore (IN); Sidhant JAIN, Bangalore (IN); Dinesh Rooparam CHOUDHARY, Bangalore (IN); Vishal YADAV, Bangalore (IN); Deepanshu GAUTAM, Bangalore (IN)

(21) Appl. No.: 19/280,583

(22) Filed: Jul. 25, 2025

(30) Foreign Application Priority Data
Jul. 26, 2024 (IN) 202441056821
Jul. 11, 2025 (IN) 2024 41056821

(51) Int. Cl. H04W 40/02; H04W 76/10

(52) U.S. Cl. CPC H04W 40/02; H04W 76/10

(57) ABSTRACT

A fifth generation (5G) or sixth generation (6G) communication system for supporting a higher data transmission rate is provided. The system includes a mobile next generation NodeB (gNB) with wireless access backhauling (MWAB) entity, the MWAB entity including at least one transceiver, at least one memory, including one or more storage media, storing instructions, and at least one processor communicatively coupled to the at least one transceiver and the at least one memory, wherein the instructions, when executed by the at least one processor individually or in any combination, cause the MWAB entity to provide, by a MWAB-gNB, a request for a protocol data unit (PDU) session including traffic descriptor information of a UE route selection policy (URSP) rule, and establish, by a MWAB-user equipment (UE), the PDU session based on the traffic descriptor information, wherein the MWAB entity comprising the MWAB-UE and the MWAB-gNB.

### CROSS-REFERENCE TO RELATED APPLICATION(S)

This application is based on and claims priority under 35 U.S.C. § 119 (a) of an Indian Provisional patent application number 202441056821, filed on Jul. 26, 2024, in the Indian Patent Office, and of an Indian Complete patent application No. 202441056821, filed on Jul. 11, 2025, in the Indian Patent Office, the disclosure of each of which is incorporated by reference herein in its entirety.

### BACKGROUND

### 1. Field

The disclosure relates to the field of wireless communication. More particularly, the disclosure relates to a method and system for managing mobile wireless access backhaul configuration through an Operations Administration and Maintenance (OAM) server.

### 2. Description of Related Art

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (TH2) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), VR (Virtual Reality), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

As the demand for seamless and uninterrupted service grows, operators are exploring the integration of terrestrial and satellite access networks within the 5G system. This integration aims to ensure service continuity between NR terrestrial access networks and NR satellite access networks, regardless of whether these networks are operated by the same entity or different entities with mutual agreements.

However, this integration poses significant technical challenges that need to be addressed to achieve optimal service delivery. One of the primary issues is the requirement for service continuity between different access networks, which may operate in different frequency bands (e.g., Frequency Range 1 (FR1) versus Frequency Range 2 (FR2)) or the same frequency band. The interoperability between terrestrial and satellite networks necessitates robust mechanisms to handle the transition and maintain service quality.

Moreover, existing systems rely on static Next Generation Node B (gNB) entities that have fixed connections with core network (CN) entities. This static nature of gNBs limits their ability to adapt to dynamic traffic conditions. For instance, during events such as sports matches, political rallies, or other large gatherings, the demand for network resources can surge significantly in specific areas. The inability of static gNBs to move and provide localized service in high-traffic areas results in suboptimal network performance and user experience.

Another major constraint is the fixed connection between gNB and CN entities, which restricts the flexibility and scalability of the network. In scenarios where gNBs need to be mobile to address fluctuating traffic conditions, the lack of dynamic interfaces for connecting to core network entities poses a significant challenge. This limitation hinders the efficient deployment of mobile gNBs, which could otherwise enhance network capacity and coverage in areas with high traffic demand.

Furthermore, the solutions designed for NR (5G Core) are also applicable to legacy Radio Access Technologies (RATs) such as E-UTRA/LTE. However, adapting these solutions to legacy systems requires replacing corresponding CN entities (e.g., Access and Mobility Management Function (AMF) with Mobility Management Entity (MME), gNB with eNB, Unified Data Management (UDM) with Home Subscriber Server (HSS), etc.). Despite these adaptations, the fundamental principles of the solutions remain the same.

Given these challenges, there is a need to develop mechanisms that enable dynamic connectivity between gNBs and core network entities. Such mechanisms facilitate the deployment of mobile gNBs, allowing them to move and serve areas with high traffic conditions efficiently. Addressing these issues significantly enhance the flexibility, scalability, and overall performance of 5G networks with satellite access.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a system and method for managing a Backhaul connection establishment or modification in wireless communication.

Another aspect of the disclosure is to provide configuration parameters to mobile wireless access backhaul (MWAB) to establish or modify the Backhaul protocol data unit (PDU) sessions to provide N2, N3, or Xn interface.

Another aspect of the disclosure is to provide the MWAB to establish the dynamic interfaces using the PDU sessions of the MWAB-UE.

Additional aspects will be set forth in part in the description which follows and, in part, will be apparent from the description, or may be learned by practice of the presented embodiments.

In accordance with an aspect of the disclosure, a method for managing a Backhaul connection establishment or modification by the OAM server in wireless communication is provided. The method includes determining by the OAM server a location information of a Mobile Wireless Access Backhaul gNB (MWAB gNB) part of a MWAB. The OAM server generates configuration parameters based on at least the location of the MWAB gNB part. The configuration parameters include at least one of security credentials, authorization information, location, time information, PLMN information, traffic descriptor information and accept or reject information. The OAM server sends the configuration parameters to the MWAB gNB part of the MWAB to establish or modify the Backhaul connection to provide at least one of N2, N3 and Xn interface.

In accordance with another aspect of the disclosure, a method performed by a mobile next generation NodeB (gNB) with wireless access backhauling (MWAB) entity is provided. The method includes providing, by a MWAB-gNB, a request for a protocol data unit (PDU) session including traffic descriptor information of a UE route selection policy (URSP) rule, and establishing, by a MWAB-user equipment (UE), the PDU session based on the traffic descriptor information, wherein the MWAB entity comprising the MWAB-UE and the MWAB-gNB.

In accordance with another aspect of the disclosure, a mobile next generation NodeB (gNB) with wireless access backhauling (MWAB) entity is provided. The MWAB entity includes at least one transceiver, at least one memory, including one or more storage media, storing instructions, and at least one processor communicatively coupled to the at least one transceiver and the at least one memory, wherein the instructions, when executed by the at least one processor individually or in any combination, cause the MWAB entity to provide, by a MWAB-gNB, a request for a protocol data unit (PDU) session including traffic descriptor information of a UE route selection policy (URSP) rule, and establish, by a MWAB-user equipment (UE), the PDU session based on the traffic descriptor information, wherein the MWAB entity comprising the MWAB-UE and the MWAB-gNB.

In accordance with another aspect of the disclosure, an OAM server for managing the Backhaul PDU session in wireless communication is provided. The OAM server includes a memory, a processor, and a MWAB controller. The MWAB controller determines a location information of a Mobile Wireless Access Backhaul gNB (MWAB gNB) part of a MWAB and generates configuration parameters based on the location of the MWAB gNB part. The configuration parameters include at least one of security credentials, authorization information, location, time information, PLMN information, traffic descriptor information and accept or reject information. The MWAB controller sends the configuration parameters to the MWAB gNB part of the MWAB to establish or modify the Backhaul connection to provide at least one of N2, N3 and Xn interface.

In accordance with another aspect of the disclosure, one or more non-transitory computer-readable storage media storing one or more computer programs including computer-executable instructions that, when executed by at least one processor of a MWAB entity individually or in any combination, cause the MWAB entity to perform operations are provided. The operations include providing, by a MWAB-gNB, a request for a protocol data unit (PDU) session including traffic descriptor information of a UE route selection policy (URSP) rule and establishing, by a MWAB-user equipment (UE), the PDU session based on the traffic descriptor information, wherein the MWAB entity comprising the MWAB-UE and the MWAB-gNB.

Aspects of the disclosure is to provide efficient communication methods in a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates the UE configuration update procedure for transparent UE Policy delivery according to an embodiment of the disclosure;

FIG. 2 illustrates the UE parameters update via the UDM control plane procedure according to an embodiment of the disclosure;

FIG. 3 is a block diagram that illustrates the hardware features of the MWAB UE according to an embodiment of the disclosure;

FIG. 4 is a block diagram that illustrates the MWAB gNB according to an embodiment of the disclosure;

FIG. 5 is a block diagram that illustrates the OAM server according to an embodiment of the disclosure;

FIG. 6 illustrates a high-level overview of MWAB according to an embodiment of the disclosure;

FIG. 7 is a sequence diagram that illustrates a method of handling MWAB configuration via OAM according to an embodiment of the disclosure;

FIG. 8 is a flow diagram that illustrates the method of managing a Backhaul connection establishment or modification by the MWAB-UE (200) in wireless communication according to an embodiment of the disclosure;

FIG. 9 is a flow diagram that illustrates the method of managing a Backhaul connection establishment or modification by the MWAB gNB (300) in wireless communication according to an embodiment of the disclosure;

FIG. 10 is a flow diagram that illustrates the method of managing a Backhaul connection establishment or modification by the OAM server (400) in wireless communication according to an embodiment of the disclosure;

FIG. 11 is a block diagram of a terminal or user equipment (UE) according to an embodiment of the disclosure;

FIG. 12 is a block diagram of a base station (BS) according to an embodiment of the disclosure; and

FIG. 13 is a block diagram of a network entity according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the embodiments, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals or different reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Furthermore, in describing the disclosure, a detailed description of known functions or constitution incorporated herein will be omitted in the case that it is determined that the description may make the subject matter of the disclosure unnecessarily unclear. The terms which will be described below are terms defined in consideration of the functions in the disclosure, and may be different according to users, intentions of the operators, or customs. Therefore, the definitions of the terms should be made based on the contents throughout the specification.

Herein, it will be understood that each block of the flowchart illustrations, and combinations of blocks in the flowchart illustrations, may be performed based on computer program instructions. These computer program instructions may be loaded collectively onto at least one processor of a general purpose computer, special purpose computer, or other programmable data processing apparatus to produce a machine, such that the instructions, which perform through any one of, or in any combination of, the at least one processor of the computer or other programmable data processing apparatus, create means for performing the functions specified in the flowchart block(s). These computer program instructions may also be stored in a non-transitory computer usable or computer-readable memory that may direct a computer or other programmable data processing apparatus to function in a particular manner, such that the instructions stored in the computer usable or computer-readable memory produce an article of manufacture including instruction means that perform the function specified in the flowchart block(s). The computer program instructions may also be loaded onto a computer or other programmable data processing apparatus to cause a series of operational steps to be performed on the computer or other programmable data processing apparatus to produce a computer executed process such that the instructions that perform on the computer or other programmable data processing apparatus provide steps for executing the functions specified in the flowchart block(s).

Further, each block may represent a module, segment, or portion of code, which includes one or more executable instructions for executing the specified logical function(s). It should also be noted that in some alternative implementations, the functions noted in the blocks may occur out of the order. For example, two blocks (or functions) shown in succession may in fact be performed substantially concurrently or the blocks may sometimes be performed in the reverse order, depending upon the functionality involved.

As used in embodiments of the disclosure, a “˜unit” may refer to a software element or a hardware element, such as a field programmable gate array (FPGA) or an application specific integrated circuit (ASIC), which performs a predetermined function. However, the term including the word “˜unit” does not always have a meaning limited to software or hardware. The “˜unit” may be constructed either to be stored in an addressable storage medium or to execute one or more processors. Therefore, the “˜unit” includes, for example, software elements, object-oriented software elements, components such as class elements and task elements, processes, functions, properties, procedures, sub-routines, segments of a program code, drivers, firmware, micro-codes, circuits, data, database, data structures, tables, arrays, and parameters. The components and functions provided by the “˜unit” may be either combined into a smaller number of components and a “˜unit,” or divided into additional components and a “˜unit.” Moreover, the components and “˜units” may be implemented to reproduce one or more central processing units (CPUs) within a device or a security multimedia card. Further, in the embodiments, the “^{˜}unit” may include one or more processors.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a CPU), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments of the disclosure may provide a program comprising code for implementing apparatus or a method as claimed in any one of the claims of this specification and a non-transitory machine-readable storage storing such a program.

Hereinafter, the determination of priority between A and B in the disclosure may refer to various actions such as selecting the one having a higher priority based on a predefined priority rule and performing an operation corresponding thereto, or omitting or dropping an operation corresponding to the one having a lower priority.

Hereinafter, “A or B” as described in the disclosure may be understood as “A and/or B,” which may include A, or B, or both A and B.

In addition, “at least one of A, B, and C” as described in the disclosure may be understood to include A, or B, or C, or any combination of A, B, and C.

In addition, “at least one of A, B, or C” as described in the disclosure may be understood to include A, or B, or C, or any combination of A, B, and C.

Furthermore, “A/B” as described in the disclosure may be understood as “A and/or B,” which may include A, or B, or both A and B.

Furthermore, “A, B” as described in the disclosure may be understood as “A and/or B,” which may include A, or B, or both A and B.

Furthermore, “A and B” as described in the disclosure may be understood as “A and/or B,” which may include A, or B, or both A and B.

Furthermore, “if condition A and condition B are satisfied,” as described in the disclosure, may not be limited to a case where both condition A and condition B are satisfied, but may be understood to include a case where either condition A or condition B is individually satisfied, both condition A and condition B are satisfied, or one or more additional conditions are satisfied in combination.

Furthermore, throughout this disclosure, ordinal terms such as “first,” “second,” “third,” etc., (and similar qualifiers) are used merely to distinguish between different instances, occurrences, configurations, messages, stages, or aspects of elements, operations, or information as described herein. Unless the context clearly dictates otherwise, the use of such ordinal terms does not itself require that the elements, operations, or information distinguished by these terms be structurally different, numerically distinct, or substantively dissimilar. For example, a “first signal” and a “second signal” may refer to instances of the same signal transmitted at different times or containing the same core information despite minor variations, or they may refer to signals with different content or characteristics, depending on the specific context. Similarly, a “first value” and a “second value” may represent the same magnitude but measured or applied in different circumstances, or they may represent different magnitudes. The interpretation should be guided by the specific technical context, function, and relationship described in the relevant portion of the specification and claims.

Furthermore, the terms “first ˜”, “second ˜”, etc., as described in the disclosure with respect to various elements (e.g., information, objects, operation, sequences, or the like), should not limit those elements. These terms may only be intended to distinguish one element from another, and may not be intended to indicate a specific order. For example, a first element could be termed a second element, and, similarly, a second element could be termed a first element.

Furthermore, even if “first ˜” and “second ˜” are described in the disclosure, it may be understood that element(s) referred to by “first ˜” and “second ˜” may be the same or different. For example, in case of element(s) being information, first information and second information may both be same information and, in some cases, are separate and different information.

In addition, the terms “if ˜” and “in case that ˜” as used in the disclosure or claims may be interpreted to include the meanings of “when (or upon) ˜,” “in response to ˜,” “based on ˜,” or “according to ˜,” and may be used interchangeably with these expressions. In addition, expressions other than those exemplified herein may also be used, as long as they have substantially the same meaning and do not impair the technical features of the disclosure.

For example, the physical layer signaling may be referred to as Layer 1 (L1) signaling and may include downlink control information (DCI). In addition, the higher layer signaling may include a medium access control (MAC) control message, a radio resource control (RRC) signaling message, a non-access stratum (NAS) signaling message, or an application layer message. The RRC signaling message may be referred to as L3 (layer 3) signaling. It should be noted, however, that the higher layer signaling is not limited to the aforementioned examples.

In addition, the term “not perform” as used in the disclosure or claims may, in context, be understood to mean that the corresponding step is omitted or skipped. Such a term may be replaced with other terms having the same or substantially equivalent meaning.

In addition, “transmitting a message including A and B” as described in the disclosure, may be understood as encompassing both (i) transmitting A and B in a single message, and (ii) transmitting A and B separately via multiple messages (e.g., transmitting a first message including A and a second message including B). This interpretation may also apply to messages that include two or more items (e.g., A, B, C), transmitted either together or separately.

In addition, “transmitting a message including A and transmitting a message including B” may also be interpreted as transmitting a message including A and B in a single message.

In the specific embodiments of the disclosure described below, terms or components included in the disclosure may be expressed in singular or plural form depending on the specific embodiments presented. However, such singular or plural expressions are selected appropriately for convenience of description, and the disclosure is not limited to a singular or plural number of components. A component expressed in the plural form may be implemented as a single component, and a component expressed in the singular form may be implemented as multiple components.

The drawings or flowcharts described below illustrate methods that may be implemented according to the principles of the disclosure, and various modifications may be made to the methods illustrated in the flowcharts of the disclosure. For example, although illustrated as a series of steps, various steps in each drawing or flowchart may overlap, occur in parallel, occur in a different order, or be repeated. In other examples, any step may be omitted or replaced with another step.

The methods and apparatuses proposed in the embodiments of the disclosure are not limited to each embodiment individually, but may also be applied in combination of all or some of the embodiments proposed in the disclosure. Therefore, the embodiments of the disclosure may be modified and applied without significantly departing from the scope of the disclosure, as would be understood by those skilled in the art.

In this case, even if certain wordings are described differently across embodiments, they may be used interchangeably or in substitution or in combination if their underlying concepts are equivalent. For example, for the same or equivalent concept, even if one embodiment uses the expression “A” and another embodiment uses the expression “B”, such expressions may be understood interchangeably, in substitution, or in combination.

The terms used in the following description to refer to access nodes, network entities, messages, interfaces between network entities, various types of identification information, and the like, are provided merely for the convenience of explanation by way of example. Therefore, the disclosure is not limited to the terms described below, and other terms having equivalent technical meanings may also be used. Such terms may also be interchangeable with terms defined in any 3rd generation partnership project (3GPP) technical specifications (TS) where appropriate.

Hereinafter, a base station is an entity that allocates resources to terminals, and may be at least one of a gNode B, an eNode B, a Node B, a base station (BS), a wireless access unit, a BS controller, or a node on a network.

Furthermore, the base station of the disclosure may include a split architecture comprising a central unit (CU) and a distributed unit (DU). In this structure, the CU is configured to process the higher layers of the control and user planes, while the DU is configured to process lower-layer radio resource functions. The embodiments of the disclosure may be equally applicable to 5G base station architectures in which such CU and DU functional splits are implemented.

A terminal may include a UE, a mobile station (MS), a cellular phone, a smartphone, a computer, or a multimedia system capable of performing communication functions.

In the disclosure, a downlink (DL) refers to a radio link through which a BS transmits a signal to a UE, and an uplink (UL) refers to a radio link through which a UE transmits a signal to a BS.

Furthermore, hereinafter, 5th generation (5G) mobile communication technologies (e.g., 5G new radio (NR)), 6th generation (6G) mobile communication technologies may be described by way of example, but the embodiments of the disclosure may also be applied to other communication systems having similar technical backgrounds or channel types. For example, newly evolved mobile communication systems developed after 5G and 6G may be included. Furthermore, based on determinations by those skilled in the art, the embodiments of the disclosure may also be applied to other communication systems (e.g., Wi-Fi systems) through some modifications without significantly departing from the scope of the disclosure

In the following description, the terms physical channel and signal may be used interchangeably with data or control signal. For example, the term physical downlink shared channel (PDSCH) refers to a physical channel through which data is transmitted, but the term PDSCH may also be used to refer to the data itself. That is, in the disclosure, the expression “transmit a physical channel” may be interpreted as being equivalent to the expression “transmit data or a signal via a physical channel.”

Hereinafter, in the context of the disclosure, higher layer signaling may refer to signaling corresponding to at least one or any combination of the following: master information block (MIB), system information block (SIB) or SIB M (M=1, 2, . . . ), radio resource control (RRC), or medium access control (MAC) control element (CE), or a non-access stratum (NAS) signaling message, or an application layer message. The RRC signaling message may be referred to as L3 (layer 3) signaling.

In addition, L1 signaling may refer to signaling corresponding to at least one or any combination of signaling techniques using the at least one or any combination of the following physical layer channels or signaling: physical downlink control channel (PDCCH), downlink control information (DCI), user equipment (UE)-specific DCI, group-common DCI, common DCI, scheduling DCI (e.g., DCI used for scheduling downlink or uplink data), non-scheduling DCI (e.g., DCI not used for scheduling downlink or uplink data) physical uplink control channel (PUCCH), or uplink control information (UCI). The L1 signaling message may be referred to as a physical layer signaling.

Hereinafter, the expression that information is configured by the BS, as used in the disclosure or claims, may, in context, be understood to mean that the terminal receives the corresponding information from the BS via a physical layer signaling or a higher layer signaling. Such an expression may be replaced with other terms having the same or substantially equivalent meaning.

Hereinafter, the operational principle of the disclosure will be described in detail with reference to the accompanying drawings.

The embodiments herein and the various features and advantageous details thereof are explained more fully with reference to the non-limiting embodiments that are illustrated in the accompanying drawings and details in the following description. Descriptions of well-known components and processing techniques are omitted so as to not unnecessarily obscure the embodiments herein. Also, the various embodiments described herein are not necessarily mutually exclusive, as some embodiments can be combined with one or more an embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The methods, issues, or solutions disclosed in an embodiment are explained using NR access or NG-RAN Access Technology as an example and are not restricted or limited to NR access only. Solutions proposed in an embodiment are also applicable for E-UTRAN access Technology, NB (Narrow Band)-S1 mode, or WB (Wide Band)-S1 mode via E-UTRAN access and/or NB-IoT (Narrowband Internet of Things) or WB-IoT (Wideband Internet of Things) Access/Architecture. Solutions defined for NR (5GC) are also applicable to legacy RATs like E-UTRA/LTE, with the corresponding CN entities needing to be replaced by LTE entities, e.g., AMF with MME, g-nodeB with e-nodeB, UDM with HSS, etc. However, the principles of the solution remain the same.

An embodiment explains the network using any 5G Core Network Function, such as AMF. The network could be any 5G/EUTRAN Core Network Entities like access and mobility management function (AMF)/session management function (SMF)/mobility management entity (MME)/user plane function (UPF) or any 5G/EUTRAN RAN Entity like evolved node b (eNodeB) (eNB), next generation node b (gNodeB) (gNB), or next generation radio access network (NG-RAN), etc. Messages used or indicated are shown as examples and could be any signaling messages between UE and the Network Functions/Entities or between different Network functions/entities. Terms such as camp and register are used interchangeably and have the same meaning. Similarly, terms like wait timer, DisCo wait timer, Discontinuous Coverage wait timer, Random timer, Random wait timer, and DCW Timer are used interchangeably and have the same meaning. Terms like wait range, Disco Wait Range, Discontinuous Coverage Wait Range, and DCW Range are also used interchangeably and have the same meaning.

In an embodiment, the term area may refer to any of cell/cell identifier (ID), tracking area code (TAC)/tracking area identity (TAI), public land mobile network (PLMN), mobile country code (MCC)/mobile network code (MNC), Latitude/longitude, any commercial and government entity code (CAG)/CAG identifier, or any geographical location/coordinate. Cause names in an embodiment are for illustration purposes and can have any name. Non-Access Stratum (NAS) messages and Access Stratum (AS) messages described in an embodiment are only for illustration purposes and can be any NAS or AS messages as per the defined protocol between UE and AMF/MME or UE and gNB (NG-RAN/any RAN node)/eNB.

An embodiment provides an example list of NAS messages, which are not limited to REGISTRATION REQUEST message, DEREGISTRATION REQUEST message, SERVICE REQUEST message, CONTROL PLANE SERVICE REQUEST, IDENTITY REQUEST, AUTHENTICATION REQUEST, AUTHENTICATION RESULT, AUTHENTICATION REJECT, REGISTRATION REJECT, DEREGISTRATION ACCEPT, SERVICE REJECT, SERVICE ACCEPT, UE CONFIGURATION UPDATE command, and UE PARAMETERS UPDATE command.

Terms related to 5GMM sublayer states in an embodiment include at least one of the following: 5GMM-NULL, 5GMM-DEREGISTERED, 5GMM-DEREGISTEREDNORMAL-SERVICE, 5GMM-DEREGISTEREDLIMITED-SERVICE, 5GMM-DEREGISTEREDATTEMPTING-REGISTRATION, 5GMM-DEREGISTEREDPLMN-SEARCH, 5GMM-DEREGISTEREDNO-SUPI, 5GMM-DEREGISTEREDNO-CELL-AVAILABLE, 5GMM-DEREGISTEREDeCALL-INACTIVE, 5GMM-DEREGISTEREDINITIAL-REGISTRATION-NEEDED, 5GMM-REGISTERED-INITIATED, 5GMM-REGISTERED, 5GMM-REGISTEREDNORMAL-SERVICE, 5GMM-REGISTEREDNON-ALLOWED-SERVICE, 5GMM-REGISTEREDATTEMPTING-REGISTRATION-UPDATE, 5GMM-REGISTEREDLIMITED-SERVICE, 5GMM-REGISTEREDPLMN-SEARCH, 5GMM-REGISTEREDNO-CELL-AVAILABLE, 5GMM-REGISTEREDUPDATE-NEEDED, 5GMM-DEREGISTERED-INITIATED, and 5GMM-SERVICE-REQUEST-INITIATED.

In an embodiment, the term EMM sublayer states include at least one of the following: EMM-NULL, EMM-DEREGISTERED, EMM-DEREGISTEREDNORMAL-SERVICE, EMM-DEREGISTEREDLIMITED-SERVICE, EMM-DEREGISTEREDATTEMPTING-TO-ATTACH, EMM-DEREGISTEREDPLMN-SEARCH, EMM-DEREGISTEREDNO-IMSI, EMM-DEREGISTEREDATTACH-NEEDED, EMM-DEREGISTEREDNO-CELL-AVAILABLE, EMM-DEREGISTEREDeCALL-INACTIVE, EMM-REGISTERED-INITIATED, EMM-REGISTERED, EMM-REGISTEREDNORMAL-SERVICE, EMM-REGISTEREDATTEMPTING-TO-UPDATE, EMM-REGISTEREDLIMITED-SERVICE, EMM-REGISTEREDPLMN-SEARCH, EMM-REGISTEREDUPDATE-NEEDED, EMM-REGISTEREDNO-CELL-AVAILABLE, EMM-REGISTEREDATTEMPTING-TO-UPDATE-MM, EMM-REGISTEREDIMSI-DETACH-INITIATED, EMM-DEREGISTERED-INITIATED, EMM-TRACKING-AREA-UPDATING-INITIATED, and EMM-SERVICE-REQUEST-INITIATED.

The term RAT as defined in an embodiment can be one of the following: NG-RAN, 5G, 4th generation (4G), 3rd generation (3G), 2nd generation (2G), evolved packet system (EPS), 5G system (5GS), NR, NR in unlicensed bands, NR (LEO) satellite access, NR (MEO) satellite access, NR (GEO) satellite access, NR (OTHERSAT) satellite access, NR RedCap, E-UTRA, E-UTRA in unlicensed bands, NB-IoT, WB-IoT, and LTE-M.

The 5GS registration types include initial registration, mobility registration updating, periodic registration updating, emergency registration, SNPN onboarding registration, disaster roaming initial registration, and disaster roaming mobility registration updating. Each type serves a specific purpose within the 5G system, ensuring proper connectivity and service continuity.

Visited PLMN (VPLMN): This is a PLMN different from the HPLMN (if the EHPLMN list is not present or is empty) or different from an EHPLMN (if the EHPLMN list is present).

Allowable PLMN: In the case of an MS operating in MS operation mode A or B, this is a PLMN which is not in the list of “forbidden PLMNs” in the MS. In the case of an MS operating in MS operation mode C or an MS not supporting A/Gb mode and not supporting Iu mode, this is a PLMN which is not in the list of “forbidden PLMNs” and not in the list of “forbidden PLMNs for GPRS service” in the MS.

Available PLMN: The PLMN(s) in the given area which is/are broadcasting capability to provide wireless communication services to the UE.

Camped on a cell: The MS (ME if there is no SIM) has completed the cell selection/reselection process and has chosen a cell from which it plans to receive all available services. Note that the services may be limited, and that the PLMN or the SNPN may not be aware of the existence of the MS (ME) within the chosen cell.

EHPLMN: Any of the PLMN entries contained in the Equivalent HPLMN list.

Equivalent HPLMN list: To allow provision for multiple HPLMN codes, PLMN codes that are within this list shall replace the HPLMN code derived from the IMSI for PLMN selection purposes. This list is stored on the USIM and is known as the EHPLMN list. The EHPLMN list may also contain the HPLMN code derived from the IMSI. If the HPLMN code derived from the IMSI is not in the EHPLMN list then it shall be treated as a Visited PLMN for PLMN selection purposes.

Home PLMN: This is a PLMN where the MCC and MNC of the PLMN identity match the MCC and MNC of the IMSI.

Registered PLMN (RPLMN): This is the PLMN on which certain LR (location registration which is also called as registration procedure) outcomes have occurred. In a shared network the RPLMN is the PLMN defined by the PLMN identity of the CN operator that has accepted the LR.

Registration: This is the process of camping on a cell of the PLMN or the SNPN and doing any necessary LRs.

UPLMN: PLMN/access technology combination in the “User Controlled PLMN Selector with Access Technology” data file in the SIM (in priority order).

OPLMN: PLMN/access technology combination in the “Operator Controlled PLMN Selector with Access Technology” data file in the SIM (in priority order) or stored in the ME (in priority order).

Existing systems feature a static gNB with a fixed connection to the core network (CN), making it difficult for the gNB to move. It is preferable to have a mobile-gNB that can move around and serve areas with high traffic conditions, such as during events like cricket, football, or political rallies. One major constraint is the fixed connection between the gNB and CN. Therefore, there is a need for a mechanism that allows the gNB to connect to core network entities dynamically through a dynamic interface.

Embodiments disclosed herein provide a method and system for managing Backhaul PDU Sessions in wireless communication. The MWAB includes a MWAB gNB part and the MWAB-UE. An OAM server configures the required parameters in the MWAB gNB part of the MWAB. These parameters are used by the MWAB-UE and the MWAB gNB part to establish or modify PDU sessions, providing connectivity for N2, N3, and Xn interfaces. The OAM server can configure the allowed area and allowed time configuration in the MWAB-gNB part, determining when it can act as MWAB-gNB and when it should not.

A system and method for handling MWAB configuration via an OAM server are disclosed. The MWAB-UE sends a registration request with an indication to act as MWAB-UE. An OAM address is shared by the OAM server with the AMF. The AMF sends a registration accept to the MWAB-UE along with the OAM address. The MWAB-UE sends a PDU establishment request with the correct DNN/S-NSSAI from URSP. Upon receiving the PDU establishment accept, the MWAB-UE connects to the OAM to fetch the required configuration. The MWAB-UE sends an OAM MWAB request or other signaling with the location of the MWAB PLMN ID where the MWAB-UE is registered or will be registered, along with one or more PLMN IDs for which the MWAB-gNB wants to broadcast or act as an MWAB-gNB. The request includes the time duration or specific slots during which the MWAB wants to broadcast as an MWAB-gNB, which could vary for different PLMNs.

Further, the MWAB-UE receives an OAM MWAB response or other signaling based on at least one parameter received in the OAM MWAB request, including security credentials if there is a security gateway between MWAB-gNB and AMF/UPF. Authorization accept or reject is based on information provided by the UE, including the area where the MWAB can act as MWAB-gNB, the time window for which the MWAB can act as MWAB-gNB, the PLMN(s) where the MWAB can broadcast as MWAB-gNB, and the traffic descriptor of URSP rules configured in the MWAB-UE to select the correct DNN S-NSSAI and other parameters for the PDU session for N2, N3, or Xn interface. The MWAB-UE forwards these configurations to the MWAB-gNB. Consequently, the MWAB acts as MWAB-gNB and starts broadcasting for PLMN-A or PLMN-B, for example.

In an embodiment, the MWAB gNB part and MWAB gNB are used interchangeably.

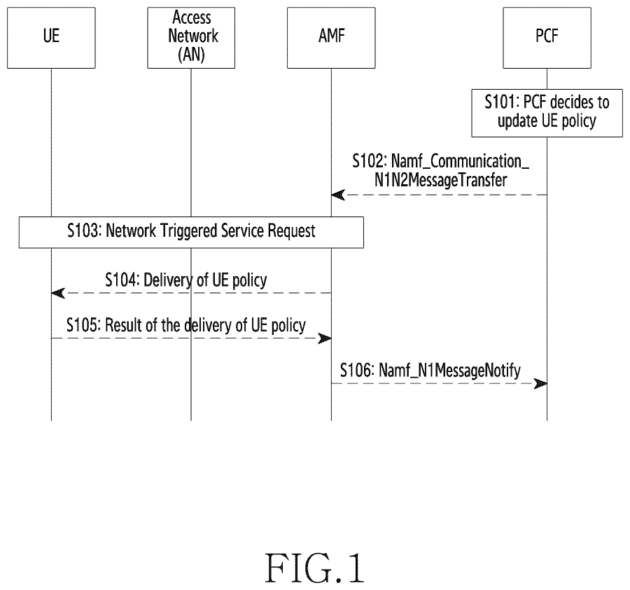

Referring now to the drawings and more particularly to FIGS. 1 through 13, where similar reference characters denote corresponding features consistently throughout the figure, these are shown preferred embodiments.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

FIG. 1 illustrates the UE configuration update procedure for transparent UE Policy delivery according to an embodiment of the disclosure. The procedure is initiated when the Policy Control Function (PCF) decides to update the User Equipment (UE) policy information within the UE configuration. In non-roaming scenarios, the V-PCF is not involved, and the PCF performs the role of the H-PCF. For roaming scenarios, the V-PCF interacts with the Access and Mobility Management Function (AMF), while the H-PCF interacts with the V-PCF.

At step S101, the PCF decides to update the UE policy based on triggering conditions such as initial registration, registration with 5GS when the UE moves from EPS to 5GS, or the need for updating the UE policy. If the PCF has not subscribed to be notified by the AMF about the UE response to an update of UE policy information, the PCF subscribes to the AMF to receive such notifications.

During step S102, the PCF invokes the Namf_Communication_N1N2 MessageTransfer service operation provided by the AMF. This message includes the Subscription Permanent Identifier (SUPI) and the UE Policy Container.

When the UE is registered and reachable by the AMF in either 3GPP access or non-3GPP access, during S103, the AMF transfers the UE Policy container transparently to the UE via the registered and reachable access. If the UE is registered in both 3GPP and non-3GPP accesses, reachable on both, and served by the same AMF, the AMF transfers the UE Policy container via one of the accesses based on the AMF's local policy. If the UE is not reachable by the AMF over both 3GPP and non-3GPP access, the AMF reports to the PCF that the UE Policy container could not be delivered using the Namf_Communication_N1N2Transfer FailureNotification.

At step S104, if the UE is in CM-CONNECTED state over 3GPP access or non-3GPP access, the AMF transfers the UE Policy container (UE policy information) received from the PCF to the UE transparently. The UE Policy container includes a list of Policy Sections, and the UE updates its configuration as illustrated at step S105. Further, the AMF forwards the response of the UE to the PCF using the Namf_Communication_N1MessageNotify at step S106.

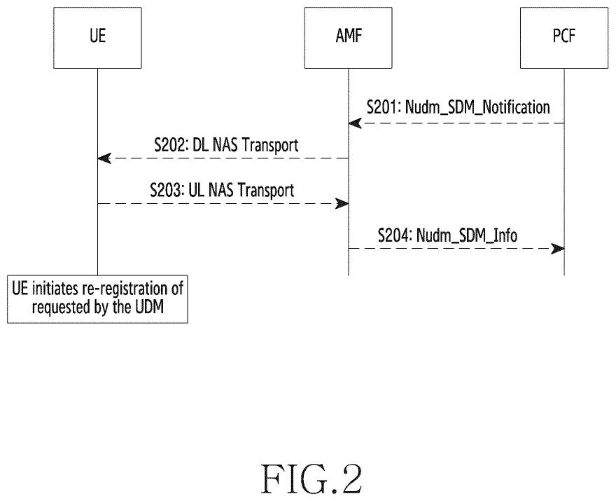

FIG. 2 illustrates the update of UE parameters via a UDM control plane procedure according to an embodiment of the disclosure. The purpose of this control plane solution for updating UE parameters is to allow the Home Public Land Mobile Network (HPLMN), Stand-alone Non-Public Network (SNPN), or CH to update the UE with a specific set of parameters generated and stored in the UDM. This is achieved by delivering protected UDM Update Data via NAS signaling. Operator policies guide the HPLMN, SNPN, or CH in updating such parameters.

The UDM decides to perform a UE parameter update and notifies the changes related to the UE to the affected AMF by invoking the Nudm_SDM_Notification service operation. This service operation contains the UDM Update Data that needs to be delivered transparently to the UE over NAS within the Access and Mobility Subscription data, as illustrated at step S201. If the UE parameter update is due to “Routing Indicator update data” and the updated Routing Indicator value is not supported by the UDM where the AMF is currently registered, the UDM requests the UE to re-register after updating the data.

At step S202, the AMF sends a DL NAS TRANSPORT message to the served UE, including the transparent container received from the UDM. Upon verifying that the UDM Update Data is provided by HPLMN, SNPN, or CH, and if the UDM has requested an acknowledgment, the UE sends an UL NAS TRANSPORT message to the serving AMF with a transparent container including the UE acknowledgment, as illustrated at step S203.

If the AMF receives an UL NAS TRANSPORT message with a transparent container carrying a UE acknowledgment, it sends a Nudm_SDM_Info request message, including the transparent container, to the UDM at step S204. When the UE parameter update is due to “Routing Indicator update data,” and the updated Routing Indicator value is supported by the UDM where the AMF is currently registered, the UDM requests the UE to send an acknowledgment but does not request re-registration. Upon receiving the transparent container indicating successful reception, the UDM triggers a Nudm_SDM_Notification service operation to update the UE Context in the AMF with the updated Routing Indicator Data. This avoids transmitting an outdated Routing Indicator during UE context transfer to another AMF.

The 5GC shall be able to provide policy information from the PCF to the UE. Such policy information includes:

1) Access Network Discovery & Selection Policy (ANDSP) is used by the UE for selecting non-3GPP accesses and for the selection of the N3IWF in the PLMN. The structure and the content of this policy are specified in clause 6.6.1.

2) UE Route Selection Policy (URSP) This policy is used by the UE to determine if a detected application can be associated with an established PDU Session, can be offloaded to non-3GPP access outside a PDU Session, or can trigger the establishment of a new PDU Session. The structure and the content of this policy are specified in clause 6.6.2. The URSP rules include traffic descriptors that specify the matching criteria and one or more of the following components: 2a) SSC Mode Selection Policy (SSCMSP) This is used by the UE to associate the matching application with SSC modes. 2b) Network Slice Selection Policy (NSSP) This is used by the UE to associate the matching application with S NSSAI. 2c) DNN Selection Policy This is used by the UE to associate the matching application with DNN. 2d) PDU Session Type Policy This is used by the UE to associate the matching application with a PDU Session Type. 2e) Non-seamless Offload Policy This is used by the UE to determine that the matching application should be non-seamlessly offloaded to non-3GPP access (i.e., outside of a PDU Session). 2f) Access Type preference If the UE needs to establish a PDU Session for the matching application, this indicates the preferred Access Type (3GPP or non-3GPP). The ANDSP and URSP may be pre-configured in the UE or may be provisioned to UE from PCF. The pre-configured policy shall be applied by the UE only when it has not received the same type of policy from PCF. The PCF selects the ANDSP and URSP applicable for each UE based on local configuration, subscribed S-NSSAIs, and operator policies, taking into consideration, e.g., accumulated usage, load level information per network slice instance, and UE location.

In an embodiment, the network may update the UE configuration at any time using the UE configuration update procedure. The UE configuration includes Access and Mobility Management related parameters, which are decided and provided by the AMF. These parameters include the Configured NSSAI and its mapping to the Subscribed S-NSSAIs, as well as the Allowed NSSAI and its mapping to the Subscribed S-NSSAIs. Additionally, the UE Policy is provided by the PCF.

When the AMF intends to change the UE configuration for access and mobility management-related parameters, the AMF initiates the procedure. Similarly, when the PCF aims to change or provide new UE Policies in the UE, the PCF initiates the procedure. If the UE Configuration Update procedure necessitates the UE to initiate a Registration procedure, the AMF explicitly indicates this to the UE.

In an embodiment, the URSPs are a collection of policies configured in the UE, which assist the applications running in the UE in determining how and which specific paths to use to send UL data for a matching data type. These policies enable the UE to decide how to route outgoing traffic. Traffic can be routed to an established PDU Session, offloaded to non-3GPP access outside a PDU Session, routed via a ProSe Layer-3 UE-to-Network Relay outside a PDU session, or trigger the establishment of a new PDU Session.

Each URSP rule includes a Traffic descriptor that determines when the rule is applicable. A URSP rule is deemed applicable when every component in the Traffic descriptor (for traffic descriptor components other than the PIN ID) matches the corresponding information from the application, matches the information configured for a PIN (if the URSP rule contains a PIN ID traffic descriptor component), or matches the information configured for a Connectivity Group (if the URSP rule contains a Connectivity Group ID traffic descriptor).

If a URSP rule is provided that contains a Traffic descriptor with two or more components, it is recommended to also provide URSP rule(s) with lower precedence and a Traffic descriptor with fewer components to increase the likelihood of URSP rule matching for a particular application.

Each URSP rule includes a list of Route Selection Descriptors, containing one or multiple Route Selection Descriptors, each having a different Route Selection Descriptor Precedence value.

TABLE 1

| | | | PCF | |
|---|---|---|---|---|
| | | | permitted | |
| Information | | | to modify | |
| Name | Description | Category | in URSP | Scope |
| Route | Determine the | Mandatory | Yes | UE |
| Selection | order in which the | (NOTE 1) | | context |
| Descriptor | Route Selection | | | |
| Precedence | Descriptors are to | | | |
| | be applied | | | |
| Route | Thes part defines | Mandatory | | |
| selection | the Route Selection | (NOTE 2) | | |
| components | components | | | |
| SSC Mode | One single value | Optional | Yes | UE |
| selection | or a list of values | | | context |
| | of S-NSSAI(s) | | | |
| Network | Either a single | Optional | Yes | UE |
| Slice | value or a list of | (NOTE 3) | | context |
| Selection | values of S- | | | |
| | NSSAI(s) | | | |
| DNN | Either a single | Optional | Yes | UE |
| Selection | value or a list of | | | context |
| | values of DNN(s). | | | |
| PDU | One single value | Optional | Yes | UE |
| Session | of PDU Session | (NOTE 8) | | context |
| Type | Type | | | |
| Selection | | | | |
| Non- | Indicates if the | Optional | Yes | UE |
| Seamless | traffic of the | (NOTE 4) | | context |
| Offload | matching | | | |
| indication | application is to | | | |
| | be offload to non- | | | |
| | 3GPP access | | | |
| | outside of a PDU | | | |
| | Session. | | | |
| Access type | Indicates the | Optional | Yes | UE |
| preference | preferred Access | | | context |
| | Type (3GPP or | | | |
| | non-3GPP or | | | |
| | Multi-Access) | | | |
| | when the UE | | | |
| | establishes a PDU | | | |
| | session for the | | | |
| | matching | | | |
| | application. | | | |
| Route | This part defines | Optional | | |
| Selection | the Route Validation | | | |
| Validation | Criteria components | | | |
| Criteria | | | | |
| (Note 6) | | | | |
| Time | The time window | Optional | Yes | UE |
| Window | when the matching | | | context |
| | traffic is allowed. | | | |
| | The RSD is not | | | |
| | considered to be | | | |
| | valid if the | | | |
| | current time is not | | | |
| | in the time window. | | | |
| Location | The UE location | Optional | Yes | UE |
| Criteria | where the | | | context |
| | matching traffic | | | |
| | is allowed. The | | | |
| | RSD rule is not | | | |
| | considered to be | | | |
| | valid if the UE | | | |
| | location does not | | | |
| | match the | | | |
| | location criteria. | | | |

In an embodiment, the purpose of the control plane solution for updating UE parameters is to allow the HPLMN to update the UE with a specific set of parameters generated and stored in the UDM. This is achieved by delivering protected UDM update data via NAS signalling, as illustrated in FIG. 2. The HPLMN updates such parameters based on the operator policies. The UDM update data delivered to the UE may contain one or more UE parameters, including the updated Default Configured NSSAI (with the final consumer of the parameter being the ME), the updated Routing Indicator Data (with the final consumer of the parameter being the USIM), a “UE acknowledgement requested” indication, and a “re-registration requested” indication.

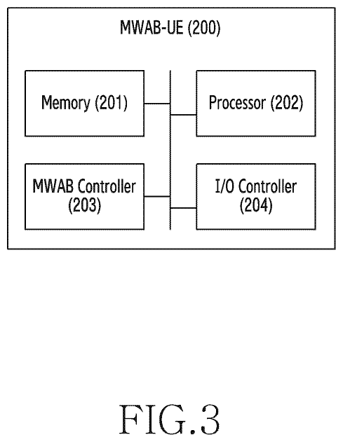

FIG. 3 is a block diagram that illustrates the hardware features of the MWAB UE, according to an embodiment of the disclosure. In an embodiment, the MWAB-UE (200) includes a memory (201), a processor (202), an input/output (I/O) interface (204), and a MWAB controller (203).

Examples of the MWAB-UE (200) can include, but are not limited to, Consumer Electronics (such as Mobile Phones and Smartphones), Tablets, Wearable Devices, Computing Devices (such as Laptops, Notebooks, Desktops, Workstations, etc.), IoT Devices, Automotive Systems (such as connected cars, Autonomous Vehicles, Vehicle-to-Everything (V2X) communication devices, etc.), Enterprise Devices such as robotics, Specialized Equipment (such as Medical Devices, Public Safety Devices, etc.), Media Devices (such as Gaming Consoles, Streaming Devices, etc.).

Examples of the wireless communication network system include, but are not limited to, Cellular Networks (such as 2G, 3G, 4G, 5G, Beyond 5G (B5G)/6G, or advanced cellular networks), Local Area Networks (LANs) (such as Wi-Fi, Li-Fi, etc.), Personal Area Networks (PANs) (such as Bluetooth, Zigbee, Z-Wave, etc.), Wide Area Networks (WANs) (such as Satellite Communication Networks, Long Range Wide Area Network, Narrowband IoT, Low-bandwidth communication for IoT, etc.), Metropolitan Area Networks (MANs), Machine-to-Machine (M2M), Ad Hoc and Mesh Networks, Emerging and Advanced Networks.

The memory (201) stores instructions to be executed by the processor (202). The memory (201) can include non-volatile storage elements. Examples of such non-volatile storage elements may include magnetic hard disks, optical disks, floppy disks, flash memories, or forms of electrically programmable memories (EPROM) or electrically erasable and programmable (EEPROM) memories. In addition, the memory (201) may in some examples be considered a non-transitory storage medium. The term non-transitory may indicate that the storage medium is not embodied in a carrier wave or a propagated signal. However, the term non-transitory should not be interpreted that the memory (201) is non-movable. In some examples, the memory (201) stores larger amounts of information. In examples, a non-transitory storage medium may store data that can over time change (e.g., in Random Access Memory (RAM) or cache). The memory (201) stores the URSP rules, traffic descriptors, application descriptors, IP descriptors, PIN IDs, configuration parameters, location information, time information and others.

The processor (202) may include one or a plurality of processors. The one or the plurality of processors may be a general-purpose processor such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (202) may include multiple cores and is configured to execute the instructions stored in the memory (201). The processor (202) fetches the URSP rules, traffic descriptors, application descriptors, IP descriptors, PIN IDs, configuration parameters, location information, time information and others. Further, the processor (202) retrieves instructions and executes them.

The I/O interface (204) transmits the information between the memory (201) and external peripheral devices. The peripheral devices are the input-output devices associated with the MWAB-gNB part (300). The I/O interface (204) receives several pieces of information from a plurality of UEs, network devices, servers, and the like. The I/O interface (204) ensures that the operating speed of the processor is synchronized with respect to the input and output devices. The I/O interface (204) establishes a connection between different peripheral devices like MWAB-gNB, memory, and others to establish Backhaul PDU session for any scenario-specific to enhance the user experience.

In an embodiment, the MWAB controller (203) of the MWAB-UE (200) communicates with the processor (202), I/O interface (204), and memory (201) to manage Backhaul PDU session establishment or modification in a wireless network system. The MWAB controller (203) receives a request message for the establishment or modification of a Backhaul PDU session from the MWAB-gNB part (300). This request message includes configuration parameters, including traffic descriptor information, and maps the traffic descriptor information with at least one Backhaul PDU session based on the RSD information configured in the URSP rule. Subsequently, the MWAB-UE (200) establishes or modifies at least one Backhaul PDU session based on the mapping.

Configuration parameters comprising traffic descriptors, further include an application descriptor, IP descriptor, domain descriptor, non-IP descriptors, Data Network Name (DNN), connection capabilities, PIN ID, Connectivity Group ID, Service and Session continuity (SSC) mode selection, network slice selection, DNN selection, PDU session type selection, allowed area information, and allowed time information. The Backhaul PDU session established or modified by the MWAB-UE provides at least one of the N2, N3, and Xn interfaces. The N2 interface is used for NAS signaling messages between the MWAB-gNB part (300) and the AMF, specifically for the control plane responsible for setting up and managing connections between devices and the network. The N3 interface connects the MWAB-gNB part (300) and the UPF, providing user plane connectivity between the 5G RAN and the 5GC, and is associated with each BH PDU session to transport user data between the RAN and the UPC. The Xn interface connects the MWAB-gNB part (300) with another gNB or NG RAN, involving UE context management for new QoS flow framework and network slice, and facilitates the handover process between RAN nodes. Interfaces are not limited to N2, N3, and Xn interfaces and can include other interfaces based on scenario-specific use cases.

The MWAB-UE (200) receives the URSP rule comprising the traffic descriptor information and the RSD information, and selects the RSD comprising the DNN, a Single Network Slice Selection Assistance Information (S-NSSAI) to establish or modify the Backhaul PDU session to provide at least one of N2, N3 and Xn interface, based on the URSP rule DNN or Single Network Slice Selection Assistance Information (S-NSSAI) or the Backhaul PDU session to provide at least one of the N2, N3, and Xn interfaces based on the URSP rule.

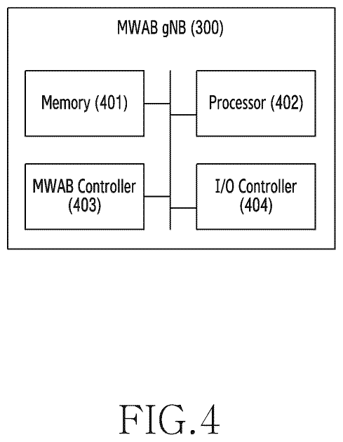

FIG. 4 is a block diagram that illustrates the MWAB gNB, according to an embodiment of the disclosure. The MWAB gNB part is a standard gNB with the added capability of using a wireless Backhaul. The MWAB gNB part (300) uses a wireless link established by the MWAB-UE to send and receive data to and from the core network.

The MWAB gNB part (300) includes any access network that can be mounted on any apparatus like but are not limited to, IoT Devices, Automotive Systems (such as connected cars, Autonomous Vehicles, Vehicle-to-Everything (V2X) communication devices, etc.), Enterprise Devices such as robotics, Specialized Equipment (such as Medical Devices, Public Safety Devices, etc.), consumer electronic products, Media Devices (such as Gaming Consoles, Streaming Devices, etc.). The MWAB gNB (300) can encompass a diverse range of devices including but not limited to AMF, SMF among others. The MWAB gNB (300) includes a memory (301), a processor (302), an I/O interface (304), and a MWAB controller (303).

The memory (301) stores instructions to be executed by the processor (302). The memory (301) can include non-volatile storage elements. Examples of such non-volatile storage elements may include magnetic hard disks, optical disks, floppy disks, flash memories, or forms of electrically programmable memories (EPROM) or electrically erasable and programmable (EEPROM) memories. In addition, the memory (301) may in some examples be considered a non-transitory storage medium. The term non-transitory may indicate that the storage medium is not embodied in a carrier wave or a propagated signal. However, the term non-transitory should not be interpreted that the memory (301) is non-movable. In some examples, the memory (301) stores larger amounts of information. In certain examples, a non-transitory storage medium may store data that can over time change (e.g., in Random Access Memory (RAM) or cache). The memory (301) stores the URSP rules, traffic descriptors, application descriptors, IP descriptors, PIN IDs, configuration parameters, location information, time information and others.

The processor (302) includes one or a plurality of processors. The one or the plurality of processors may be a general-purpose processor such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (302) may include multiple cores and is configured to execute the instructions stored in the memory (301). The processor (302) fetches the URSP rules, traffic descriptors, application descriptors, IP descriptors, PIN IDs, configuration parameters, location information, time information and others. Further, the processor (302) retrieves instructions and executes them.

The I/O interface (304) transmits the information between the memory (301) and external peripheral devices. The peripheral devices are the input-output devices associated with the MWAB-UE (200). The I/O interface (304) receives several pieces of information from a plurality of UEs, network devices, servers, and the like. The I/O interface (304) ensures that the operating speed of the processor is synchronized with respect to the input and output devices. The I/O interface (304) establishes a connection between different peripheral devices like MWAB-gNB, memory, and others to establish Backhaul PDU session for any scenario-specific to enhance the user experience.

In an embodiment, the MWAB controller (303) of the MWAB-gNB (300) communicates with the processor (302), I/O interface (304), and memory (301) to manage Backhaul PDU session establishment or modification in a wireless network system. Configuration parameters are received by the MWAB controller (303) from the OAM server (400), wherein the configuration parameters comprise at least one of security credentials, authorization information, area information, time information, PLMN information, traffic descriptor information, and accept or reject information. The MWAB gNB part (300) forwards the configuration parameters, including traffic descriptor information, to the MWAB-UE (200) and activates or deactivates an MWAB-gNB operation based on the received configuration parameters.

In an embodiment, the traffic descriptor information of the URSP rules in the MWAB-UE (200) is used to select a correct Route Selection Descriptor comprising at least one of the DNN, S-NSSAI, or PDU session, where the PDU session comprises an already established PDU session or a new PDU session for at least one of the N2, N3, or Xn interfaces.

In an embodiment, the MWAB gNB part (300) activates or deactivates the MWAB-gNB operation based on the received configuration parameters. The MWAB gNB part (300) receives at least one allowed area and the restricted or non-allowed area from the OAM server (400) and receives at least one of an allowed time window and a restricted or non-allowed time window from the OAM server (400). Furthermore, the MWAB gNB part (300) activates the MWAB-gNB operation to act as the MWAB gNB in the allowed area and activates the MWAB-gNB operation during the allowed time window. Further the MWAB gNB part (300) deactivates the MWAB-gNB operation to stop MWAB-gNB operation in the restricted or non-allowed area during the restricted or non-allowed time window.

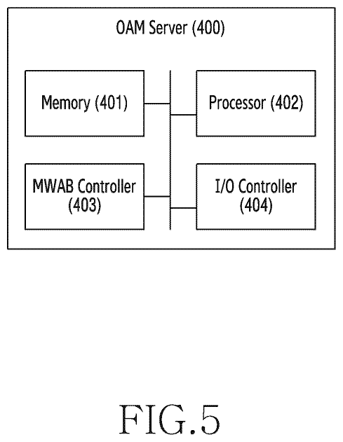

FIG. 5 is a block diagram that illustrates the OAM server (400), according to an embodiment of the disclosure. In an embodiment, the OAM server (400) includes a memory (401), a processor (402), an I/O interface (404), and a MWAB controller (403). The OAM server (400) manages and monitors the network's performance and health. They provide a central interface for tasks like user administration, configuration, fault management, and upgrades. The OAM server (400) encompasses the processes, activities, and tools used to operate, administer, manage, and maintain the backhaul network.

The OAM server encompasses diverse apparatus like but not limited to, Diameter Signaling Router (DSR) OAM server, Ethernet OAM, Packet Transport Network (PTN) OAM servers among others.

The memory (401) stores instructions to be executed by the processor (402). The memory (401) can include non-volatile storage elements. Examples of such non-volatile storage elements may include magnetic hard disks, optical disks, floppy disks, flash memories, or forms of electrically programmable memories (EPROM) or electrically erasable and programmable (EEPROM) memories. In addition, the memory (401) may in some examples be considered a non-transitory storage medium. The term non-transitory may indicate that the storage medium is not embodied in a carrier wave or a propagated signal. However, the term non-transitory should not be interpreted that the memory (401) is non-movable. In some examples, the memory (401) stores larger amounts of information. In certain examples, a non-transitory storage medium may store data that can over time change (e.g., in Random Access Memory (RAM) or cache). The memory (401) stores the URSP rules, traffic descriptors, application descriptors, IP descriptors, PIN IDs, configuration parameters, location information, time information and others.

The processor (402) includes one or a plurality of processors. The one or the plurality of processors may be a general-purpose processor such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (402) may include multiple cores and is configured to execute the instructions stored in the memory (401). The processor (402) fetches the URSP rules, traffic descriptors, application descriptors, IP descriptors, PIN IDs, configuration parameters, location information, time information and others. Further, the processor (402) retrieves instructions and executes them.

The I/O interface (404) transmits the information between the memory (401) and external peripheral devices. The peripheral devices are the input-output devices associated with the MWAB-UE (200) and the MWAB gNB (300). The I/O interface (404) receives several pieces of information from a plurality of UEs, network devices, servers, and the like. The I/O interface (404) ensures that the operating speed of the processor is synchronized with respect to the input and output devices. The I/O interface (404) establishes a connection between different peripheral devices like MWAB-gNB, memory, and others to establish Backhaul PDU session for any scenario-specific to enhance the user experience.

In an embodiment, the MWAB controller (403) of the OAM server (400) communicates with the processor (402), I/O interface (404), and memory (401) to manage Backhaul PDU session establishment or modification in a wireless network system. The MWAB controller (403) determines a location information of a Mobile Wireless Access Backhaul gNB (MWAB gNB) part (300) of the MWAB. The MWAB controller (403) generates the configuration parameters based on the location of the MWAB gNB part (300). The configuration parameters include at least one of security credentials, authorization information, location, time information, PLMN information, traffic descriptor information and accept or reject information. Further the MWAB controller (403) sends the configuration parameters to the MWAB gNB part of the MWAB to assist in establishing or modifying the Backhaul connection to provide at least one of N2, N3 and Xn interface.

In an embodiment, the OAM server (400) generates the configuration parameters. The server configures at least one of the following parameters per Protocol Data Unit (PDU) session of N2, per PDU session of Xn, and per PDU session of N3 for any number of PDU sessions: application descriptors comprising an Operating System Identifier (OSId) and Operating System Application Identifier(s) (OSAppId(s)); IP descriptors comprising destination IP 3 tuple(s) including an IP address or IPv6 network prefix, port number, and protocol ID of the protocol above IP; Domain descriptors comprising Fully Qualified Domain Name(s) (FQDN(s)) or a regular expression used as a domain name matching criteria. Additionally, the OAM server (400) configures Non-IP descriptors comprising descriptor(s) for destination information of non-IP traffic, Data Network Name (DNN) matched against the DNN information provided by an application, Connection capabilities matched against information provided by a User Equipment (UE) application when requesting a network connection with certain capabilities or traffic categories, Personal Identification Number (PIN) ID matched against a PIN ID for a specific PIN configured in the Policy and Charging Enforcement Function (PCEF), and Connectivity Group ID matched against a Connectivity Group ID for a specific Connectivity Group configured in the 5G Residential Gateway (5G-RG).

In yet an embodiment, the OAM server (400) defines at least one of an allowed area where the MWAB acts as the MWAB-gNB and a restricted or non-allowed area where the MWAB cannot act as the MWAB-gNB. The server also defines at least one allowed time window during which the MWAB acts as the MWAB-gNB and a restricted or non-allowed time window during which the MWAB cannot act as the MWAB-gNB. The OAM server (400) sends the allowed area and the restricted or non-allowed area to the MWAB-gNB for activation or deactivation of MWAB-gNB operation at the MWAB-gNB. Additionally, the server sends at least one of the allowed time window and the restricted or non-allowed time window to the MWAB-gNB for activation or deactivation of MWAB-gNB operation at the MWAB-UE.

While FIGS. 3, 4, and 5 illustrate the hardware components of the MWAB-UE (200), MWAB gNB (300), and the OAM server (400) respectively, the alternative embodiments may include different or additional components. The labels or names of these elements are illustrative and do not limit the disclosure's scope. Components may also be combined to perform similar functions.

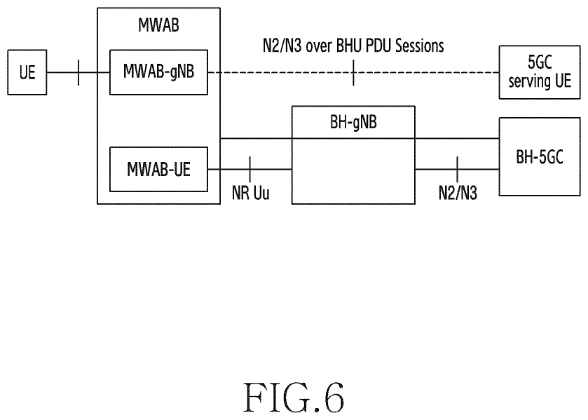

FIG. 6 illustrates a high-level overview of MWAB according to an embodiment of the disclosure. The mobile gNB with MWAB provides an NR access link to UEs in proximity and connects to the 5GC serving the UE through IP connectivity provided by Backhaul PDU sessions. The MWAB consists of a gNB component (MWAB-gNB) and a UE component (MWAB-UE). Mounted on a moving vehicle, the MWAB may serve UEs inside or outside the vehicle. The MWAB-UE (200) establishes IP connectivity for the backhaul links for the MWAB-gNB (300) via NR Uu using the existing registration procedure and PDU session establishment procedure. These backhaul links are between the MWAB-gNB (300) and entities of the network (e.g., AMF, UPF, other gNBs, and OAM server) that a MWAB-gNB (300) cell serves. The IP connectivity provided by the MWAB-UE (200) may be either via the same PLMN/SNPN that the MWAB-gNB serves or a different PLMN/SNPN, depending on the MWAB-UE PLMN selection mechanism.

The MWAB, illustrated in FIG. 6, is a mobile base station that acts as a gNB for other UEs and provides access to 5G networks, i.e., providing an NR access link to UEs and connecting wirelessly to the 5GC (using NR) through IP connectivity provided by PDU sessions established via a NG-RAN cell that the mobile gNB can camp on. The PDU session is provided either by a Terrestrial Network or by a Non-Terrestrial Network. Such a mobile gNB may be mounted on a moving vehicle and serve UEs located inside or outside the vehicle (or entering/leaving the vehicle).

MWAB operation supports both PLMN and SNPN cases. When the MWAB-gNB (300) serves a PLMN, the UEs served by MWAB may be non-roaming or roaming in the MWAB Broadcasted PLMN. In case the MWAB-gNB serves a SNPN, the subscribed SNPN of the UEs may differ from the MWAB Announced SNPN. The UEs served by the MWAB are not aware of the network serving the MWAB-UE.

Authorization of the MWAB-UE (200) is based on its subscription information, which includes dedicated S-NSSAI(s) and DNN for MWAB operation. Such dedicated S-NSSAI(s) and DNN(s) are part of the subscription information for the MWAB-UE (200). MWAB-UE authorization supports time-based or location-based control. For time-based control, existing time-based network slice subscription control can be reused. For location-based control, existing mechanisms, e.g., service area restriction, LADN-based control, can be reused.

The OAM server (400) of the MWAB Broadcasted PLMN/SNPN manages the authorization of the MWAB-gNB (300). The MWAB-gNB establishes a secure and trusted connection with the OAM server (400) using IP connectivity provided by the MWAB-UE (200) via Backhaul PDU Session(s).

The OAM server (400) of the MWAB Broadcasted PLMN/SNPN determines when/where the MWAB-gNB can operate or when/where it needs to shut down. Pre-configuration by the OAM server (400) of the MWAB Broadcasted PLMN/SNPN may turn on/shut down the operations of respective MWAB Broadcasted PLMN/SNPN parts. When the MWAB-gNB is no longer authorized to operate by the OAM server (400) of the MWAB Broadcasted PLMN/SNPN, the MWAB-gNB should hand over the UE(s) of the MWAB Broadcasted PLMN/SNPN to other cells.

Configuration from OAM of the MWAB Broadcasted PLMN/SNPN supports the use of multiple BH PDU Sessions for MWAB-gNB N2, N3, Xn interfaces, and OAM server access.

The MWAB gNB requests BH PDU Session(s) from the MWAB-UE by providing corresponding traffic descriptors via implementation-based internal communication between the MWAB gNB and the MWAB-UE.

Based on received traffic descriptors from MWAB-gNB, configured URSP rules, and local configuration, the MWAB-UE establishes and modifies BH PDU Sessions. The MWAB-UE may establish and modify BH PDU Sessions based on necessary information provided by MWAB-gNB (e.g., according to QoS requirements identified by the MWAB-gNB based on QoS information of the PDU Session(s) in the UE contexts of the MWAB-gNB and/or based on OAM configuration) via implementation-based internal communication between MWAB-gNB and MWAB-UE.

When Xn is supported for MWAB, the MWAB-gNB and its neighbor NG-RAN node set proper DSCP for the Xn-U traffic based on OAM configurations. Additionally, the MWAB gNB marks the DSCP value based on configuration for N2, Xn-C, and OAM traffic it sources, i.e., not related to PDU Session(s) of the UE.

The MWAB-gNB provides information to the MWAB-UE for mapping DSCP values used for N3 traffic and Xn traffic in the MWAB Broadcasted PLMN/SNPN to QoS flows to be used in the BH PLMN/SNPN (including the required Packet Filter Set for filtering packets) and corresponding QoS requirements (e.g., QoS Flow level parameters including 5QI). The MWAB-UE then initiates backhaul PDU session establishment or modification procedures to establish or update BH PDU session(s) for N3 traffic and Xn traffic delivery based on the received information.

Configuration of a MWAB gNB part (300) can associate S-NSSAI(s) in the MWAB-Broadcasted PLMN/SNPN to the traffic descriptor for selection of BH PDU Sessions parameters, e.g., use dedicated S-NSSAI in BH PLMN. If no such association exists for specific S-NSSAIs of the MWAB Broadcasted PLMN/SNPN, the MWAB-gNB associates this S-NSSAI to default traffic descriptors for the selection of BH PDU Session(s) for related N2 and/or N3 backhauling.

A UE is authorized to act as a MWAB-UE and MWAB-gNB (e.g., UE is authorized for MWAB operations). Connected to the 5G core, a MWAB-gNB provides an NR access link to UEs and connects wirelessly (using NR) through a wireless access backhaul to the 5G Core.

The MWAB-gNB part (300) broadcasts the PLMN(s) (e.g., PLMN-1, PLMN-2) for which it optionally provides services. UE-1 is registered to PLMN-1 via MWAB (e.g., via MWAB-gNB and/or MWAB-UE). Similarly, UE-2 is registered to PLMN-2 via MWAB (e.g., via MWAB-gNB and/or MWAB-UE). The interaction between MWAB and OAM, including any message exchanges. Additionally, the configuration of an MWAB with the information on whether it can act as an MWAB-gNB (300) requires clarification. Specifically, it is not known whether and how an MWAB can act as an MWAB-gNB for: a specific PLMN or a group of PLMNs, a particular area or everywhere geographically, and a specific time window or all the time.

To address the challenges in conventional methods, the disclosure proposes the following solutions. All necessary information regarding the configuration of an MWAB, including how, where, when, and for which PLMNs an MWAB can act as MWAB-gNB, will be provided to the MWAB by the OAM server (400). The OAM server address, such as IP address, FQDN, etc., will be pre-configured in the MWAB. This configuration can be achieved through NAS or other signaling messages from the home network or serving network to the MWAB, pre-configuration in SIM/USIM, or other mechanisms where the address is sent over the air from OAM to an MWAB. Alternatively, any mechanism in which the OAM address is provided to the MWAB can be used, which can be per PLMN-ID (the PLMN-ID that the MWAB-gNB is going to act as or represent).

The MWAB will reach out to the required IP address/FQDN to retrieve the necessary configuration-related information. The DNN and S-NSSAI used to establish the required PDU session are derived from the URSP rules configured in the MWAB-UE.

To get the necessary information, the MWAB sends a request to the OAM to fetch the information, and provides the following parameters in the request:

Location of the MWAB: this could be TA/cell/CAG/area/geolocation of the MWAB where the MWAB wants to broadcast as MWAB-gNB. This could be different/same for different PLMNs (i.e., information can be per PLMN ID). For example, the MWAB could indicate information such as the TA location, i.e., PLMN-A TAC-A cell-ID A, or geo-location, which will be geo-location coordinates.

At least one or more PLMN ID(s) where the MWAB-UE is registered or will be registered to act as MWAB.

PLMN ID/set of PLMN IDs for which the MWAB-gNB wants to broadcast/act as an MWAB-gNB. For example, MWAB can indicate registered PLMN such as PLMN-A or other PLMN(s) alongside, for example, PLMN-B, PLMN-C, etc.

Time duration or specific slots of time during which the MWAB wants to broadcast as an MWAB-gNB. This could be different/same for different PLMNs (i.e., information can be per PLMN ID). For example, MWAB can indicate a specific date and time such as 20 Jun. 2025, 4 pm to 10 pm of the day, or periodic time stamps such as 20 Jun. 2025 to 20 Jul. 2025, 10 am to 5 pm of every day, etc.

The OAM server (400) responds to above request based on the inputs of Request, local configuration and operator policy, and includes at least one of the following information for the MWAB:
Security credentials if there is a security gateway between MWAB-gNB and AMF/UPF; and
N2/N3 is the reference point between the AMF/UPF and the 5G-AN. N2 is used, among other things, to carry NAS signalling traffic between the UE and the AMF over 3GPP and non-3GPP accesses and N3 is used to carry data between NG-RAN and UPF.

The transport of control plane data over N2 shall be integrity, confidentiality, and replay-protected. To protect the N2 reference point, it is required to implement IPsec ESP and IKEv2 certificates-based authentication as specified in sub-clause 9.12 of the 33501. IPsec is mandatory to implement on the MWAB-gNB and the ng-eNB (MWAB-gNB). On the core network side, a SEG may be used to terminate the IPsec tunnel. To terminate the IPsec tunnel at the SEG, the related security parameters like certifications, identifiers, or related keys, and not limited to this, etc., are configured by OAM in MWAB-gNB and the SEG.

Mutual authentication shall be supported over the N2 interface between the AMF and the 5G-AN using DTLS and/or IKEv2. In addition to IPsec, DTLS shall be supported as specified in RFC6083 [58] to provide mutual authentication, integrity protection, replay protection, and confidentiality protection. Security profiles for DTLS implementation and usage shall follow the TLS profile given in clause 6.2 of TS 33210 [3] and the certificate profile given in clause 6.13a of TS 33310 [5]. The identities in the end entity certificates shall be used for authentication and policy checks. All the parameters, identifiers, and certificates used for the authentication and security procedures are configured in MWAB-gNB and Security gateway (SeGW) by the OAM.

Authorization accept or reject is based on information provided by the UE (also called as MWAB in the context of this disclosure). If accepted, the MWAB or the UE acts as MWAB-gNB; if rejected, it does not act as MWAB-gNB. The area where the MWAB can act as MWAB-gNB (allowed area) or optionally the area where the MWAB cannot act as MWAB-gNB (restricted or non-allowed area) is determined by the OAM. For example, if the OAM indicates that the MWAB can act as MWAB-gNB in allowed areas, it acts as MWAB-gNB only in the allowed area and does not act as MWAB-gNB in the restricted or non-allowed area.

The time window for which the MWAB can act as MWAB-gNB (i.e., allowed time window) or cannot act as MWAB-gNB (i.e., restricted or non-allowed time window) is specified. For example, if the allowed time window indicates 20th June from 10 am to 5 μm, the MWAB acts as MWAB-gNB only during this period and does not act as MWAB-gNB at any other time.

The PLMN(s) for which the MWAB can broadcast or is allowed to act as MWAB-gNB, or PLMNs for which the MWAB is strictly not allowed to act as MWAB-gNB, are specified. For example, if allowed PLMN(s) are PLMN-A and PLMN-B, then the MWAB acts as MWAB-gNB only for these two PLMNs.

The traffic descriptor of URSP rules configured in the MWAB-UE selects the correct DNN, S-NSSAI, or the PDU session, i.e., already established PDU session, a new PDU session for N2, N3, or Xn interface, or any other interfaces.

Parameters configured in MWAB-UE/MWAB-gNB by the OAM include at least one of the following. These parameters can be configured per PDU session of N2, per PDU session of Xn, per PDU session of N3, and can be for any number of PDU sessions. In an embodiment, these parameters can be applicable for a given area (i.e., based on location criteria) or the time slot (i.e., based on time window criteria) as described below:

Application descriptors: OSId and OSAppId(s);
IP descriptors: Destination IP 3 tuple(s) (IP address or IPv6 network prefix, port number, protocol ID of the protocol above IP);
Domain descriptors: FQDN(s) or a regular expression used as a domain name matching criteria;
Non-IP descriptors: Descriptor(s) for destination information of non-IP traffic;
DNN: Matched against the DNN information provided by the application;
Connection Capabilities: Matched against the information provided by a UE application when it requests a network connection with certain capabilities or traffic categories;
PIN ID: Matched against a PIN ID for a specific PIN configured in the PEGC;
Connectivity Group ID: Matched against a Connectivity Group ID for a specific Connectivity Group configured in the 5G-RG;
SSC Mode Selection: One single value of SSC mode;
Network Slice Selection: Either a single value or a list of values of S-NSSAI(s);
DNN Selection: Either a single value or a list of values of DNN(s);
PDU Session Type Selection: One single value of PDU Session Type;
Non-Seamless Offload indication: Indicates if the traffic of the matching application is to be offloaded to non-3GPP access outside of a PDU Session;
ProSe Layer-3 UE-to-Network Relay Offload indication: Indicates if the traffic of the matching application is to be sent via a ProSe Layer-3 UE-to-Network Relay outside of a PDU Session;
ProSe Multi-path Preference: Indicates if the traffic of the matching application is preferred to be sent via a PDU Session over the Uu reference point and a ProSe Layer-3 UE-to-Network Relay outside of a PDU Session;
Access Type preference: Indicates the preferred Access Type (3GPP or non-3GPP or Multi-Access) when the UE establishes a PDU Session for the matching application;
PDU Session Pair ID: An indication shared by redundant PDU Sessions as described in clause 5.3.3.2.1 of TS 23501 [2];
RSN: The RSN as described in clause 5.3.3.2.1 of TS 23501 [2]; and
The above parameters are provided by MWAB-gNB to MWAB-UE to perform the selection of the parameters using the route selection descriptor of the URSP rules to establish the PDU session, e.g., the SSC mode, DNN, S-NSSAI, etc., or the above parameters are directly used by the MWAB-UE/MWAB-gNB to establish the PDU session.

Optionally, all the required information can be configured/pre-configured in the MWAB/MWAB-gNB configured/pre-configured by the serving PLMN, i.e., the PLMN the MWAB-UE is registered to and configured/pre-configured by HPLMN/E-HPLMN of the MWAB-UE.

When the MWAB cannot get this necessary configuration information, cannot reach out to the OAM server, or is rejected, then it will not act as an MWAB-gNB.

All the above information can be configured, pre-configured, or provided on a per PLMN basis, a group of PLMNs, or equivalent PLMNs.

In an embodiment, the configurations regarding the server details (e.g., OAM server details) include at least one of the following, or any combination thereof: The IP address of the server (e.g., OAM server); The FQDN of the server (e.g., OAM server); The DNN to be used for PDU session establishment; The S-NSSAI to be used for PDU session establishment; The allowed area (as defined in an embodiment) where the UE is permitted to connect to the server (e.g., OAM server); The allowed time during which the UE is permitted to connect to the server (e.g., OAM server); The allowed VPLMN or HPLMN (on which the UE is camped or registered) where the UE is permitted to connect to the server (e.g., OAM server); For the VPLMN or HPLMN, the MWAB-gNB can act as a gNB, i.e., the PLMN on which the MWAB-gNB needs to integrate and function as a gNB

When the UE lacks configurations regarding server details (e.g., OAM server details), it shall not function as a MWAB-UE but rather as a normal UE. The UE may initiate NAS procedures such as the registration request procedure, UCU procedure, or session management procedure, and indicate to the network function (e.g., AMF or SMF) that it requires configurations about the server details. Optionally, this request can be for the current camped PLMN or the PLMN-2, which needs to be broadcasted by MWAB-gNB, meaning MWAB-gNB will act as the gNB of that particular network of PLMN-2. In response to this request, the network function will configure the server details (e.g., OAM server details).

MWAB-UE DNN/S-NSSAI may be configured in URSP rules. One or more MWAB-UE DNNs may be added to the DNN selection list in the Route Selection Descriptor (RSD), and/or one or more MWAB-UE N-SSAIs may be added to the Network Slice Selection list in the Route Selection Descriptor.

In one embodiment, these MWAB-UE DNNs and/or S-NSSAIs may be explicitly configured or pre-configured in the SIM/USIM/ESIM, ME, or UE. An embodiment allows these configurations to be explicitly configured or pre-configured in the MWAB-UE or MWAB-gNb. Optionally, configurations can be set per PLMN, per area, per time, or any combination thereof. The PLMN can be either VPLMN or HPLMN.

In an embodiment, the UE connects to a server over the data path (i.e., through PDU session connectivity) which provides the configurations about the server details (e.g., OAM server details). The details to connect to such a server can include at least one of the following: the IP address of the server (e.g., which provides the configurations about the server details, such as OAM server details), the FQDN of the server (e.g., which provides the configurations about the server details, such as OAM server details), the DNN to be used for PDU session establishment, the S-NSSAI to be used for PDU session establishment, the allowed area (as defined in an embodiment) where the UE is allowed to connect to the server (which provides the configurations about the server details, such as OAM server details), the allowed time where the UE is allowed to connect to the server (which provides the configurations about the server details, such as OAM server details), and the allowed VPLMN or HPLMN (on which the UE is camped or registered) where the UE is allowed to connect to the server (which provides the configurations about the server details, such as OAM server details). Additionally, for the VPLMN or HPLMN, the MWAB-gNB can act as a gNB, i.e., the PLMN on which the MWAB-gNB needs to integrate and act as a gNB.

The details to connect to such a server over the data path can be provided to the UE following the same mechanisms as described in an embodiment to provide the configurations about the server details (e.g., OAM server details), i.e., either in NAS message like 5GMM, 5GSM, or PCO/ePCO in 5GSM message, etc.

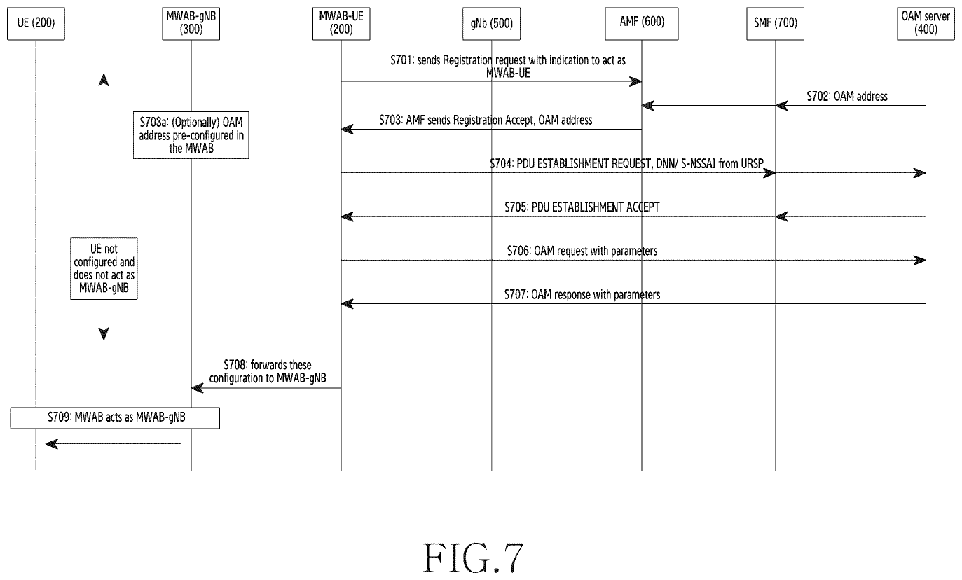

FIG. 7 is a sequence diagram that illustrates a method of handling MWAB configuration via OAM server according to an embodiment of the disclosure.

At step S701, the MWAB-UE (200) sends a Registration request with an indication to act as MWAB-UE. At step S702, the OAM server (400) shares the OAM server address with the AMF (600) through the SMF (700).

At step S703, the AMF (600) sends Registration Accept to MWAB-UE (200) along with the OAM address. At step S704, the MWAB-UE (200) sends PDU ESTABLISHMENT REQUEST with correct DNN/S-NSSAI from URSP.

At step S705, the MWAB-UE receives PDU ESTABLISHMENT ACCEPT, hence MWAB UE is connected to the OAM to fetch the required configuration. At step S706, the MWAB-UE sends OAM MWAB request or other signalling with:
Location of the MWAB, this could be TA/cell/geolocation of the MWAB, where the MWAB wants to broadcast as MWAB-gNB;
The PLMN ID where the MWAB-UE is registered or is going to registered with;
PLMN ID/set of PLMN IDs (i.e. one or more PLMN IDs) for which the MWAB-gNB wants to broadcast/act as an MWAB-gNB;
Time, duration or specific slots of time during which the MWAB wants to broadcast as an MWAB-gNB, this could be different/same for different PLMNs.

At step S707, the MWAB-UE receives OAM MWAB response or some other signalling based on the at least one parameter received in OAM MWAB request with:
Security credentials if there is a security gateway between MWAB-gNB and AMF/UPF;
Authorization, accept or reject based on information provided by the UE;
Area where the MWAB can act as MWAB-gNB;
Time window for which the MWAB can act as MWAB-gNB;
The PLMN(s) where the MWAB can broadcast as MWAB-gNB; these are the PLMN ID the MWAB-gNB will act as NG-RAN.

The traffic descriptor of URSP rules configured in the MWAB-UE to select correct DNN, S-NSSAI for N2, N3 or Xn interface. Or other parameters, i.e. the directly the PDU session parameters e.g. DNN, S-NSSAI, SSC mode etc. can be configured in the MWAB-gNB/MWAB-UE, which it uses the establish the one or more PDU session for e.g. to send the data/signalling related to N2, N3 or Xn interface on respective PDU sessions.

At step S708, the MWAB-UE forwards these configuration to MWAB-gNB. This step is shown only for illustration purpose. The OAM configurations as shown in an embodiment, can be directly configured by OAM into the MWAB-gNB which will be transparent to MWAB-UE for e.g. it can be over the data path of MWAB-UE or using any other mechanism.

At step S709, the MWAB acts as MWAB-gNB and starts broadcasting for PLMN-A/PLMN-B for example. MWAB-UE/MWAB-gNB need to connect to OAM server. The MWAB-UE/MWAB-gNB will connect to Provisioning MnS Producer using PnC procedures defined in 28.314/5/6. No change is expected in PnC endures. A gNB should be made capable of behaving as MWAB-gNB. Create a MWABFunction IOC. The attributes will include at least one of the below parameters and other parameters,

Authorized MWABInfo <<datatype>>:

AllowedAreaInfo: Area where the gNB can act as MWAB-gNB or area where the gNB cannot act as MWAB-gNB. If the OAM indicates that the MWAB can act as MWAB-gNB in allowed areas, it acts as MWAB-gNB only in the allowed area and does not act as MWAB-gNB in the restricted or non-allowed area.

AllowedTimewindowInfo: Time window for which the gNB can act as MWAB-gNB (i.e., allowed time window) or cannot act as MWAB-gNB (i.e., restricted or non-allowed time window). For example, if the allowed time window/validity indicates 20th June 10 am to 5 μm of the day, the gNB acts as an MWAB-gNB only during 20th June 10 am to 4 μm of the day and does not act as MWAB-gNB for any other time.

AllowedPLMNInfo: The PLMN(s) for which the gNB can broadcast or is allowed to act as MWAB-gNB or PLMNs for which the gNB is strictly not allowed to act as MWAB-gNB. For example, if the allowed PLMN(s) is PLMN-A, PLMN-B, then the MWAB acts as MWAB-gNB only for these 2 PLMNs.

AllowedSliceInfo: The S-NSSAI for which the gNB is allowed to act as MWAB-gNB or S-NSSAI for which the gNB is strictly not allowed to act as MWAB-gNB. For example, if the allowed S-NSSAI is Slice-A, Slice-B, then the gNB acts as MWAB-gNB only for these 2 S-NSSAI.

AllowedTimeQuota: The total duration of time for which a gNB can act as MWAB-gNB. For example, if the allowed quota is 5 hours, then gNB can only act as MWAB-gNB for a total of 5 minutes. After that time, the MWAB-gNB will be de-provisioned by the OAM system and other parameters.

Requested MWABInfo: <<datatype>> will have at least one of the below parameters and other parameters.

RequestedAreaInfo: Area where the gNB wants to act as MWAB-gNB.

RequestedTimewindowInfo: Time window for which the gNB wants to act as MWAB-gNB.

RequestedPLMNInfo: The PLMN(s) which gNB wants to broadcast.

RequestedSliceInfo: The slice which gNB wants to support. MWABFunction IOC will be name contained with ManagedEntity (<<proxyClass>> Subnetwork or ManagedElement). The relationship would be 1 to 01.

GNBCUCPFunction will have a direct association with MWABFunction. The relationship would be 1 to 01. MWABFunction IOC will inherit from Top.

Communication between MWAB-gNB and OAM: Assuming MWAB-gNB has reached Provisioning MnS Procedure using PnC procedures. MWAB-gNB as Provisioning MnS Consumer will send modifyMOIAttributes (MWABFunction) operation to update the requested MWABInfo <<datatype>>. Provisioning MnS Producer updates the authorized MWABInfo <<datatype>> to represent what MWAB-gNB is authorized for. MWAB-gNB shall be notified by the authorization by notifyMOIAttributeChange notifications.

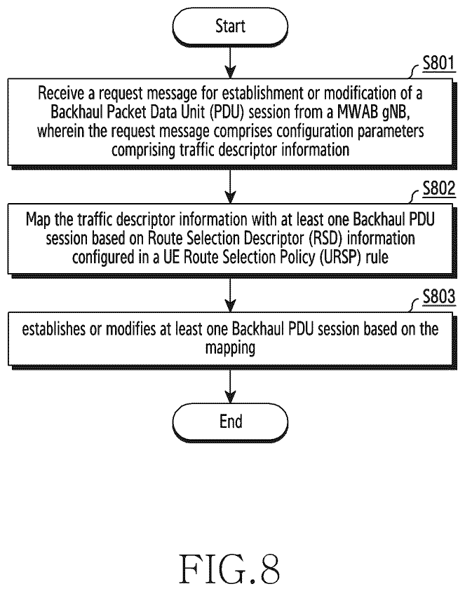

FIG. 8 is a flow diagram illustrating the method of managing a Backhaul connection establishment or modification by the MWAB-UE (200) in wireless communication according to an embodiment of the disclosure. At operation S801, the MWAB-UE (200) receives a request message for the establishment or modification of a Backhaul PDU session from the MWAB-gNB (300). The request message includes configuration parameters, including traffic descriptor information. The MWAB-UE (200) maps the traffic descriptor information with at least one Backhaul PDU session based on RSD information configured in the URSP rule, as illustrated at operation S802.

In operation S803, the MWAB-UE (200) establishes or modifies at least one Backhaul PDU session based on the mapping. In an embodiment, the configuration parameters include at least one of the following: an application descriptor, IP descriptor, domain descriptor, non-IP descriptors, Data Network Name (DNN), connection capabilities, PIN ID, a Connectivity Group ID, Service and Session continuity (SSC) mode selection, network slice selection, DNN selection, PDU session type selection, allowed area information, and allowed time information. The Backhaul PDU session established or modified by the MWAB-UE (200) provides at least one of the N2, N3, and Xn interfaces.

The MWAB-UE (200) receives the URSP rule comprising the traffic descriptor information and the RSD information. Based on the URSP rule, the MWAB-UE (200) selects the RSD comprising at least one of a DNN, a Single Network Slice Selection Assistance Information (S-NSSAI), to establish or modify Backhaul PDU session to provide at least one of the N2, N3, and Xn interfaces.

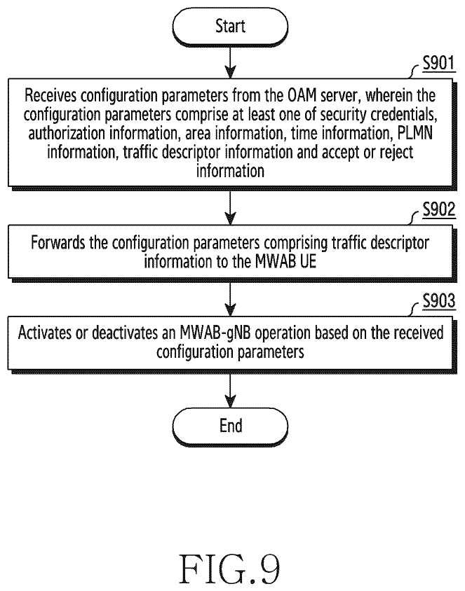

FIG. 9 is a flow diagram illustrating the method of managing a Backhaul connection establishment or modification by the MWAB gNB (300) in wireless communication according to an embodiment of the disclosure. At operation S901, the MWAB gNB (300) receives configuration parameters from an Operations Administration and Maintenance (OAM) server. These configuration parameters include at least one of the following: security credentials, authorization information, area information, time information, PLMN information, traffic descriptor information, and accept or reject information.

In operation S902, the MWAB gNB (300) forwards the configuration parameters, including traffic descriptor information, to the MWAB-UE (200). Additionally, the MWAB gNB (300) activates or deactivates an MWAB-gNB operation based on the received configuration parameters, as illustrated in operation S903.

In one embodiment, the MWAB gNB (300) indicates the traffic descriptor information of URSP rules in the MWAB-UE (200) to select a correct RSD comprising DNN, S-NSSAI, or PDU session. The PDU session may include an already established PDU session or a new PDU session for at least one of the N2, N3, or Xn interfaces.

The MWAB gNB (300) receives at least one allowed area and the restricted or non-allowed area from the OAM server. It also receives at least one allowed time window and a restricted or non-allowed time window from the OAM server. The MWAB gNB (300) activates the MWAB-gNB operation to act as the MWAB gNB in the allowed area during the allowed time window and deactivates the MWAB-gNB operation to stop MWAB-gNB operation in the restricted or non-allowed area during the restricted or non-allowed time window.

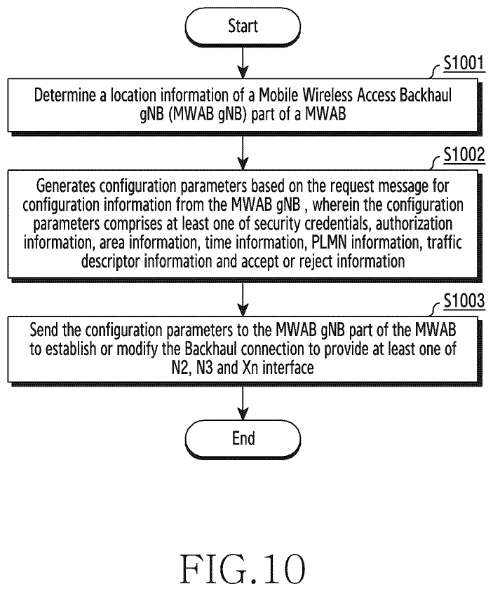

FIG. 10 is a flow diagram illustrating the method of managing a Backhaul connection establishment or modification by the OAM server (400) in wireless communication according to an embodiment of the disclosure. At operation S1001, the OAM server (400) determines the location of the MWAB gNB part (300). Subsequently, the OAM server (400) generates configuration parameters based on the request message for configuration information from the MWAB gNB, as illustrated at operation S1002. These configuration parameters include at least one of the following: security credentials, authorization information, area information, time information, PLMN information, traffic descriptor information, and accept or reject information.

At operation S1003, the OAM server (400) sends the configuration parameters to the MWAB gNB (300). In an embodiment, the OAM server (400) configures at least one of the following parameters per Protocol Data Unit (PDU) session of N2, per PDU session of Xn, and per PDU session of N3 for any number of PDU sessions: application descriptors comprising an Operating System Identifier (OSId) and Operating System Application Identifier(s) (OSAppId(s)); IP descriptors comprising destination IP 3 tuple(s) including an IP address or IPv6 network prefix, port number, and protocol ID of the protocol above IP; Domain descriptors comprising Fully Qualified Domain Name(s) (FQDN(s)) or a regular expression used as a domain name matching criteria. Additionally, the OAM server (400) configures Non-IP descriptors comprising descriptor(s) for destination information of non-IP traffic, Data Network Name (DNN) matched against the DNN information provided by an application, and connection capabilities matched against information provided by the UE application when requesting a network connection with certain capabilities or traffic categories. Furthermore, the OAM server (400) configures Personal Identification Number (PIN) ID matched against a PIN ID for a specific PIN configured in the Policy and Charging Enforcement Function (PCEF) and Connectivity Group ID matched against a Connectivity Group ID for a specific Connectivity Group configured in the 5G Residential Gateway (5G-RG).

The OAM server of the MWAB Broadcasted PLMN/SNPN provides (re-)configuration parameters considering location of MWAB, e.g. for the purpose including the access stratum operation of the MWAB-gNB, the N2, N3 and Xn interface management, activating/deactivating the MWAB-gNB operation and to assist the MWAB-gNB providing traffic descriptor information used by MWAB-UE for the BH PDU Session(s) management via URSP processing. The MWAB-gNB requests BH PDU Session(s) from the MWAB-UE by providing corresponding traffic descriptors, via the implementation based internal communication between the MWAB-gNB and the MWAB-UE. The MWAB-UE establishes, modifies BH PDU Sessions based on the received traffic descriptors from MWAB-gNB, configured URSP rules, and local configuration.

In an embodiment, the OAM server (400) defines at least one of an allowed area where the MWAB acts as the MWAB-gNB and a restricted or non-allowed area where the MWAB cannot act as the MWAB-gNB. The allowedArea specifies the area where the MWAB can act as MWAB-gNB. If the OAM indicates that the MWAB can act as MWAB-gNB is allowed areas, it acts as MWAB-gNB only on the allowed area only. It also defines at least one allowed time window for which the MWAB acts as the MWAB and a restricted or non-allowed time window for which the MWAB cannot act as the MWAB-gNB. Additionally, the allowedTime this species the time window for which the MWAB can act as MWAB-gNB. If the allowed time window/validity indicates 20th June 10 am to 5 μm of the day, the MWAB acts as an MWAB g-NB only during 20th June 10 am to 5 μm of the day, and does not act as MWAB-gNB for any other time. The OAM server (400) sends the at least one allowed area and the restricted or non-allowed area to the MWAB-gNB for activation or deactivation of an MWAB-gNB operation at the MWAB-gNB. Additionally, it sends at least one of the allowed time window and the restricted or non-allowed time window to the MWAB-gNB for activation or deactivation of an MWAB-gNB operation at the MWAB-UE. If both area and time are allowed the MWAB acts as a MWAB-gNB. In yet another embodiment if at least one of the allowedArea and allowedTime are allowed, the MWAB acts as MWAB-gNB.

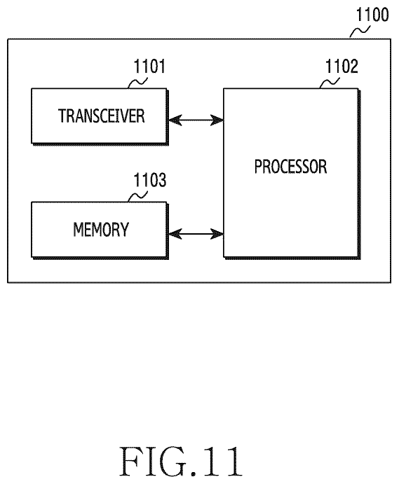

FIG. 11 is a block diagram of a terminal or user equipment (UE) 1100 according to an embodiment of the disclosure. The UE 1100 of FIG. 11 corresponds to the MWAB-UE of FIG. 2.

The terminal is an electronic device capable of wireless communication, may include a User Equipment (UE), a portable phone, a smartphone, a tablet, an Internet of things (IoT) device, etc., having various form factors, and may perform wireless communication with a base station (BS) through a wireless channel.

Referring to FIG. 11, the UE 1100 may include at least one transceiver (hereinafter, referred to as simply “transceiver”) 1101, at least one processor (hereinafter, referred to as simply “processor”) 1102, and at least one memory (hereinafter, referred to as simply “memory”) 1103. According to at least one or a combination of methods corresponding to the embodiments described in the disclosure, the transceiver 1101, the processor 1102, and the memory 1103 of the UE 1100 may operate. However, components of the UE 1100 are not limited to the components illustrated in FIG. 11. In another embodiment, the UE 1100 may further include additional components in addition to the above-mentioned components, or some components may be omitted. Further, in some embodiments, any combination of the transceiver 1101, the processor 1102, or the memory 1103 may be integrated in the form of one component.

The transceiver 1101 may be a communication circuit or communication circuitry that enables the UE 1100 to perform wireless communication with a node or an entity of a network. For example, the transceiver 1101 may enable the UE 1100 to transmit or receive a signal to or from a BS through cellular communication, or to transmit or receive a signal to or from another UE through cellular communication. For example, the transceiver 1101 may support at least one of various cellular communication technologies including 3rd generation (3G), 4th generation (4G), long term evolution (LTE), 5th generation (5G) NR, 6th generation (6G), and various cellular wireless communication technologies supported by the transceiver (1101) may include all subsequent generations of evolved wireless communications.

According to an embodiment, the UE 1100 may include a plurality of transceivers. For example, in the case of supporting evolved-universal terrestrial radio access-new radio (E-UTRA-NR) dual connectivity (EN-DC), the UE 1100 may include a first transceiver supporting the 4G LTE wireless communication and a second transceiver supporting the 5G NR wireless communication. According to another embodiment, in the case of supporting NR-dual connectivity (NR-DC), the UE 1100 may include a plurality of transceivers supporting the 5G NR wireless communication. According to still another embodiment, in the case of supporting near field wireless communication, the UE 1100 may separately include a transceiver supporting at least one standard in the group of wireless communication protocol standards as defined in the protocol standards for Bluetooth®, wireless local area network (WLAN) network (including institute of electrical and electronics engineers (IEEE) 802.11-2016 standard or its amendments, e.g., 802.11ah, 802.11ad, 802.11ay, 802.11ax, 802.11az, 802.11ba, and 802.11be, without being limited thereto).

According to an embodiment, the transceiver 1101 may include various circuit structures used to transmit or receive signals to or from a BS through a wireless channel. The signals may include control information and data. For example, the transceiver 1101 may include a radio frequency (RF) transmitter for up-converting and amplifying the frequency of a transmitted signal and an RF receiver for low-noise-amplifying a received signal and down-converting the frequency thereof. The transceiver 1101 may output a signal received through a wireless channel to the processor 1102 and may transmit, through a wireless channel, a signal output from the processor 1102.

The processor 1102 may control general operations of the UE 1100 according to embodiments of the disclosure. The processor 1102 may be implemented by one or more integrated circuit (or circuitry) (IC) chips and may execute various data processings. The processor 1102 may include at least one electric circuit, and may execute instructions (or a program, codes, data, etc.) stored in the memory 1103, individually, collectively or in any combination thereof. Further, the processor 1102 may include a single-core processor or multi-core processor, and may include a processor assembly including a plurality of processing circuits (circuitry) according to a specific implementation scheme.

The processor 1102 may be electrically, operatively, or communicatively coupled to the transceiver 1101 to control the transceiver 1101.

The processor 1102 may include at least one processor (or processing circuitry), and the at least one processor may perform the following operations individually, collectively or in any combination thereof. For example, the processor 1102 may include a communication processor (CP) configured to control communication operations and an application processor (AP) configured to control execution of an upper layer (for example, an application layer). In a specific embodiment, at least a part of the processor 1102 may be included in one chip and the other part of the processor 1102 may be included in another chip. Otherwise, at least one processor may be included in another component, for example, the transceiver 1101 or the memory 1103.

The processor 1102 may perform or control or cause an operation of the UE 1100 for executing at least one or a combination of methods according to embodiments of the disclosure. For example, the processor 1102 may control operations of the UE 1100 for processing a downlink signal received from a BS or generating and transmitting an uplink signal to a BS. To this end, the processor 1102 may execute a computer program, codes, or instructions stored in the memory 1103, so as to control other components of the UE 1100 to enable execution of various operations.

The memory 1103 corresponds to a hardware storage device capable of temporarily or permanently storing information and may include one or more storage media. For example, the memory 1103 may include a memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 1103 may be electrically, operatively, or communicatively coupled to the processor 1102 and may be accessed by the processor 1102.

The memory 1103 may store a computer program, codes, or instructions executable by the processor 1102. According to an embodiment, a computer program, codes, or instructions executable by the processor 1102 may be either stored in a single memory device or separated and distributedly stored in two or more memory devices. By executing the instructions stored in the memory 1103, the processor 1102 may perform various functions according to an embodiment of the disclosure.

According to an embodiment of the disclosure, operations of the UE 1100 may be caused to be performed based on execution of instructions (or a computer program or codes) stored in the memory 1103 by at least one processor (or processing circuitry) configured to execute the same individually, collectively, or in any combination thereof, based on processing circuitry that is not configured to execute instructions, and/or based on components of processing circuitry that is not configured to execute instructions.

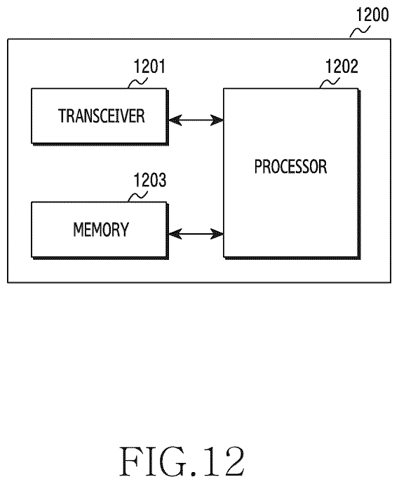

FIG. 12 is a block diagram of a base station (BS) 1200 according to an embodiment of the disclosure. The BS 1200 of FIG. 12 corresponds to the MWAB-gNB of FIG. 3.

The BS 1200 may perform wireless communication with at least one user equipment (UE) located within the area of the BS 1200 through a wireless channel.

Referring to FIG. 12, the BS 1200 may include at least one transceiver (hereinafter, referred to as simply “transceiver”) 1201, at least one processor (hereinafter, referred to as simply “processor”) 1202, and at least one memory (hereinafter, referred to as simply “memory”) 1203. According to at least one or a combination of methods corresponding to the embodiments described in the disclosure, the transceiver 1201, the processor 1202, and the memory 1203 of the BS 1200 may operate. However, components of the BS 1200 are not limited to the components illustrated in FIG. 12. In another embodiment, the BS 1200 may further include additional components in addition to the above-mentioned components, or some components may be omitted. Further, in some embodiments, any combination of the transceiver 1201, the processor 1202, or the memory 1203 may be integrated in the form of one component.

The transceiver 1201 may be a communication circuit or communication circuitry that enables the BS 1200 to perform wireless communication with a node or an entity of a network. For example, the transceiver 1201 may enable the BS 1200 to transmit or receive a signal to or from the UE 1120 through cellular communication, or to transmit or receive a signal to or from another network entity through wireless communication. For example, the transceiver 1201 may support various cellular communication technologies including 3rd generation (3G), 4th generation (4G), long term evolution (LTE), 5th generation (5G) NR, 6th generation (6G), and various cellular wireless communication technologies supported by the transceiver (1201) may include all subsequent generations of evolved wireless communications. According to an embodiment, the transceiver 1201 may include various circuit structures used to transmit or receive signals to or from a UE through a wireless channel. The signals may include control information and data. For example, the transceiver 1201 may include a radio frequency (RF) transmitter for up-converting and amplifying the frequency of a transmitted signal and an RF receiver for low-noise-amplifying a received signal and down-converting the frequency thereof. The transceiver 1201 may output a signal received through a wireless channel to the processor 1202 and may transmit, through a wireless channel, a signal output from the processor 1202.

Meanwhile, according to an embodiment of the disclosure, the BS 1200 may perform communication with a node or an entity of a network through wired or wireless communication. For example, the BS 1200 may perform wired or wireless communication with an adjacent BS, or a node or an entity of a core network through a backhaul network. Although not illustrated in FIG. 12, when the BS 1200 performs wired communication, the BS 1200 may further include a separate network interface for wired communication in addition to the transceiver 1201. The network interface may be referred to as network interface circuitry or communication interface circuitry.

The processor 1202 may control general operations of the BS 1200 according to embodiments of the disclosure. The processor 1202 may be implemented by one or more integrated circuit (or circuitry) (IC) chips and may execute various data processings. The processor 1202 may include at least one electric circuit, and may execute instructions (or a program, codes, data, etc.) stored in the memory 1203, individually, collectively or in any combination thereof. Further, the processor 1202 may include a single-core processor or multi-core processor, and may include a processor assembly including a plurality of processing circuits (circuitry) according to a specific implementation scheme.

The processor 1202 may be electrically, operatively, or communicatively coupled to the transceiver 1201 to control the transceiver 1201.

The processor 1202 may include at least one processor (or processing circuitry), and the at least one processor may perform the following operations individually, collectively or in any combination thereof. In a specific embodiment, at least a part of the processor 1202 may be included in one chip and the other part of the processor 1202 may be included in another chip. Otherwise, at least one processor may be included in another component, for example, the transceiver 1201 or the memory 1203.

The processor 1202 may perform or control or cause an operation of the BS 1200 for executing at least one or a combination of methods according to embodiments of the disclosure. For example, the processor 1202 may control operations of the BS 1200 for generating and transmitting a downlink signal to a UE or processing an uplink signal received from a UE. Otherwise, the BS 1200 may transmit or receive a signal to or from a neighboring BS, transfer a signal received from a UE to an upper node of the network, or transmit a signal transferred from an upper node of the network to a UE. To this end, the processor 1202 may execute a computer program, codes, or instructions stored in the memory 1203, so as to control other components of the BS 1200 to enable execution of various operations.

The memory 1203 corresponds to a hardware storage device capable of temporarily or permanently storing information and may include one or more storage media. For example, the memory 1203 may include a memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 1203 may be electrically, operatively, or communicatively coupled to the processor 1202 and may be accessed by the processor 1202.

The memory 1203 may store a computer program, codes, or instructions executable by the processor 1202. According to an embodiment, a computer program, codes, or instructions executable by the processor 1202 may be either stored in a single memory device or separated and distributedly stored in two or more memory devices. By executing the instructions stored in the memory 1203, the processor 1202 may perform various functions according to an embodiment of the disclosure.

According to an embodiment of the disclosure, operations of the BS 1200 may be caused to be performed based on execution of instructions (or a computer program or codes) stored in the memory 1203 by at least one processor (or processing circuitry) configured to execute the same individually, collectively, or in any combination thereof, based on processing circuitry that is not configured to execute instructions, and/or based on components of processing circuitry that is not configured to execute instructions.

The UE or the base station may perform various communication procedures related to the control plane or the user plane by cooperating with one or more network entities based on wireless communication. For example, the UE may communicate with network entity such as an Access and Mobility Management Function (AMF) or a Session Management Function (SMF) via the base station, or the base station may perform at least one communication procedure by directly transmitting and receiving signals to/from, or relaying signals between, the network entities.

The structure of the above-described network entity will be described in more detail with reference to the drawings.

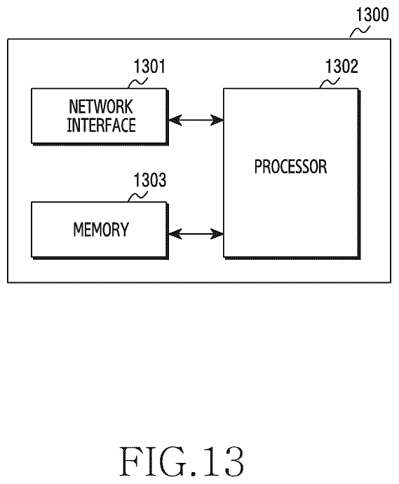

FIG. 13 is a block diagram of a network entity 1300 according to an embodiment of the disclosure. The network entity 1300 of FIG. 13 includes at least one of a MWAB entity, a MWAB-UE, or a MWAB-gNB.

The network entity 1300 may include an entity (apparatus, device, or server, etc.) that performs one or more network functions (NFs) or a part of a network function constituting a core network (e.g., a 5th generation (5G) core (5GC)) in a communication system. In this case, multiple NFs may be implemented within a single network entity, or a single NF may be distributed and implemented across a plurality of network entities. In addition, when an NF is implemented within the network entity, the NF may be implemented in the form of software, and in such a case, a program for operating the NF may be stored in memory of the network entity 1300.

A single NF may be implemented by one or more instances, which may be deployed on the same network entity or distributed across multiple network entities to operate. The instance may be a software unit that logically executes a specific network function, and may be implemented in a form that is decoupled from physical hardware resources. Further, one or more NFs may be implemented in the form of one network slice to operate to satisfy specifications required by a particular service.

The NF may include at least one of an access and mobility management function (AMF), a session management function (SMF), a local session management function (L-SMF), a user plane function (UPF), a local user plane function (L-UPF), a policy control function (PCF), a unified data management (UDM), a unified data repository (UDR), a network exposure function (NEF), a network repository function (NRF), an application function (AF), a network slice selection function (NSSF), a network data analytics function (NWDAF), a network slice admission control function (NSACF), an authentication server function (AUSF), or a data network (DN).

Referring to FIG. 13, the network entity 1300 may include at least one network interface 1301, at least one processor 1302 (hereinafter, “processor”), and at least one memory 1303 (hereinafter, “memory”). As described above, a NF may be implemented in the form of a physical device such as the network entity 1300, or may be virtualized and executed in the form of an instance. When implemented as an instance, the NF need not necessarily include physical components as illustrated in FIG. 13. In such a case, the instance may be logically represented as comprising one or more logical functional elements.

According to at least one or a combination of methods corresponding to the embodiments described in the present disclosure, the network interface 1301, the processor 1302, and the memory 1303 of the network entity 1300 may operate.

However, components of the network entity 1300 are not limited to the exemplary components illustrated in FIG. 13. In another embodiment, the network entity 1300 may further include additional components in addition to the above-mentioned components, or some components may be omitted. Further, in an embodiment, the network interface 1301, the processor 1302, or the memory 1303 may be integrated in the form of one component.

The network interface 1301 is a collective term for a transmitter part of the network entity 1300 and a receiver part of the network entity 1300, and may be a communication circuit for transmitting or receiving a signal to or from a user equipment (UE), a base station (BS), or another network entity. Here, the communication circuit may include both a communication circuit for wireless communication and a communication circuit for a wired communication. For example, the network interface 1301 may include a circuit, logic, hardware, etc., configured to exchange a control plane message or a user plane message with a UE, a BS, or other core network entities through wireless communication or wired communication. The network interface 1301 may operate using various protocols (e.g., non-access stratum (NAS) protocol). The network interface 1301 may also be referred to, for convenience of description or depending on implementation, as communication circuitry, network interface circuitry, or a communication interface circuitry.

The processor 1302 may control general operations of the network entity 1300 according to embodiments of the disclosure. The processor 1302 may be implemented by one or more integrated circuit (or circuitry) (IC) chips and may execute various data processings. The processor 1302 may include at least one electric circuit, and may execute instructions (or a program, codes, data, etc.) stored in the memory 1303, individually, collectively or in any combination thereof. Further, the processor 1302 may include a single-core processor or multi-core processor, and may include a processor assembly including a plurality of processing circuits (circuitry) according to a specific implementation scheme. Further, it should be noted that, according to another embodiment, in a case where NF is implemented in the form of an instance, the network function may be not necessarily configured by physical hardware.

According to an embodiment, the processor 1302 may be electrically, operatively, or communicatively coupled to the network interface 1301 to control the network interface 1301.

The processor 1302 may include at least one processor (or processing circuitry), and the at least one processor may perform the following operations individually, collectively or in any combination thereof. In a specific embodiment, at least a part of the processor 1302 may be included in one chip and the other part of the processor 1302 may be included in another chip. Otherwise, at least one processor may be included in another component, for example, the network interface 1301 or the memory 1303.

The processor 1302 may perform or control or cause an operation of the network entity 1300 for executing at least one or a combination of methods according to embodiments of the disclosure. For example, the processor 1302 may control operations of the network entity 1300 for exchanging a control plane message or a user plane message with a UE, a BS, or other core network entities through wireless or wired communication, using various protocols (e.g., NAS protocol). To this end, the processor 1302 may execute a computer program, codes, or instructions stored in the memory 1303, so as to control other components of the network entity 1300 to enable execution of various operations.

The memory 1303 corresponds to a hardware storage device capable of temporarily or permanently storing information and may include one or more storage media. For example, the memory 1303 may include a memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 1303 may be electrically, operatively, or communicatively coupled to the processor 1302 and may be accessed by the processor 1302.

The memory 1303 may store a computer program, codes, or instructions executable by the processor 1302. According to an embodiment, a computer program, codes, or instructions executable by the processor 1302 may be either stored in a single memory device or separated and distributedly stored in two or more memory devices. By executing the instructions stored in the memory 1303, the processor 1302 may perform various functions according to an embodiment of the disclosure.

According to an embodiment of the disclosure, operations of the network entity 1300 may be caused to be performed based on execution of instructions (or a computer program or codes) stored in the memory 1303 by at least one processor (or processing circuitry) configured to execute the same individually, collectively, or in any combination thereof, based on processing circuitry that is not configured to execute instructions, and/or based on components of processing circuitry that is not configured to execute instructions.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a mobile next generation NodeB (gNB) with wireless access backhauling (MWAB) entity, the method comprising:
providing, by a MWAB-gNB, a request for a protocol data unit (PDU) session including traffic descriptor information of a UE route selection policy (URSP) rule; and
establishing, by a MWAB-user equipment (UE), the PDU session based on the traffic descriptor information,
wherein the MWAB entity comprising the MWAB-UE and the MWAB-gNB.

2. The method of claim 1, wherein the traffic descriptor information is configured by an operation administration maintenance (OAM) server.

3. The method of claim 1, wherein the PDU session is for at least one of a N2 interface, a N3 interface, or a Xn interface.

4. The method of claim 1, wherein the traffic descriptor information includes at least one of:
application descriptors being an operating system (OS) identifier (ID) and an OS application ID;
internet protocol (IP) descriptors being a destination IP 3 tuple, the destination IP 3 tuple including an IP address or an IPV6 network prefix, a port number, and a protocol ID;
domain descriptors being a fully qualified domain name (FQDN) or a regular expression which are used as a domain name matching criteria;
non-IP descriptors being for destination information of non-IP traffic;
data network names (DNNs) being matched against DNN information provided by an application;
connection capabilities being matched against information provided by a UE application when it requests a network connection with certain capabilities or traffic categories;
a personal internet of things (IoT) network (PIN) identifier (ID) being matched against a PIN ID for a specific PIN configured in a PIN element with gateway capability (PEGC); or
a connectivity group ID being matched against a connectivity group ID for a specific connectivity group configured in a fifth generation-residential gateway (5G-RG).

5. The method of claim 1, further comprising:
receiving, from an OAM server, information configuring at least one of first information on an allowed area or second information on an allowed time window.

6. The method of claim 5,
wherein the first information indicates an area where the MWAB entity can act as the MWAB-gNB, and
wherein the second information indicates a time window for which the MWAB entity can act as the MWAB-gNB.

7. A mobile next generation NodeB (gNB) with wireless access backhauling (MWAB) entity comprising:
at least one transceiver;
at least one processor communicatively coupled to the at least one transceiver; and
at least one memory, communicatively coupled to the at least one processor, storing instructions executable by the at least one processor individually or in any combination to cause the MWAB entity to:
provide, by a MWAB-gNB, a request for a protocol data unit (PDU) session including traffic descriptor information of a UE route selection policy (URSP) rule, and
establish, by a MWAB-user equipment (UE), the PDU session based on the traffic descriptor information,
wherein the MWAB entity comprising the MWAB-UE and the MWAB-gNB.

8. The MWAB entity of claim 7, wherein the traffic descriptor information is configured by an operation administration maintenance (OAM) server.

9. The MWAB entity of claim 7, wherein the PDU session is for at least one of a N2 interface, a N3 interface, or a Xn interface.

10. The MWAB entity of claim 7, wherein the traffic descriptor information includes at least one of:
application descriptors being an operating system (OS) identifier (ID) and an OS application ID;
internet protocol (IP) descriptors being a destination IP 3 tuple, the destination IP 3 tuple including an IP address or an IPV6 network prefix, a port number, and a protocol ID;
domain descriptors being a fully qualified domain name (FQDN) or a regular expression which are used as a domain name matching criteria;
non-IP descriptors being for destination information of non-IP traffic;
data network names (DNNs) being matched against DNN information provided by an application;
connection capabilities being matched against information provided by a UE application when it requests a network connection with certain capabilities or traffic categories;
a personal internet of things (IoT) network (PIN) identifier (ID) being matched against a PIN ID for a specific PIN configured in a PIN element with gateway capability (PEGC); or
a connectivity group ID being matched against a connectivity group ID for a specific connectivity group configured in a fifth generation-residential gateway (5G-RG).

11. The MWAB entity of claim 7, wherein the instructions further cause the MWAB entity to:
receive, from an OAM server, information configuring at least one of first information on an allowed area or second information on an allowed time window.

12. The MWAB entity of claim 11,
wherein the first information indicates an area where the MWAB entity can act as the MWAB-gNB, and
wherein the second information indicates a time window for which the MWAB entity can act as the MWAB-gNB.

13. One or more non-transitory computer-readable storage media storing computer-executable instructions that, when executed by at least one processor of a mobile next generation NodeB (gNB) with wireless access backhauling (MWAB) entity individually or collectively, cause the MWAB entity to perform operations, the operations comprising:
providing, by a MWAB-gNB, a request for a protocol data unit (PDU) session including traffic descriptor information of a UE route selection policy (URSP) rule; and
establishing, by a MWAB-user equipment (UE), the PDU session based on the traffic descriptor information,
wherein the MWAB entity comprising the MWAB-UE and the MWAB-gNB.

14. The computer-readable storage media of claim 13,
wherein the traffic descriptor information is configured by an operation administration maintenance (OAM) server, and
wherein the PDU session is for at least one of a N2 interface, a N3 interface, or a Xn interface.

15. The computer-readable storage media of claim 13, wherein the traffic descriptor information includes at least one of:
application descriptors being an operating system (OS) identifier (ID) and an OS application ID;
internet protocol (IP) descriptors being a destination IP 3 tuple, the destination IP 3 tuple including an IP address or an IPV6 network prefix, a port number, and a protocol ID;
domain descriptors being a fully qualified domain name (FQDN) or a regular expression which are used as a domain name matching criteria;
non-IP descriptors being for destination information of non-IP traffic;
data network names (DNNs) being matched against DNN information provided by an application;
connection capabilities being matched against information provided by a UE application when it requests a network connection with certain capabilities or traffic categories;
a personal internet of things (IoT) network (PIN) identifier (ID) being matched against a PIN ID for a specific PIN configured in a PIN element with gateway capability (PEGC); or
a connectivity group ID being matched against a connectivity group ID for a specific connectivity group configured in a fifth generation-residential gateway (5G-RG).
